(19) United States
(12) Patent Application Publication
(10) Pub. No.: US 2004/0109175 A1
(43) Pub. Date: Jun. 10, 2004

(54) Print service method and print service apparatus

(75) Inventors: Kazushige Hatori, Saitama (JP); Toru Kimura, Kanagawa (JP); Kikuo Naito, Kanagawa (JP); Masato Fukuda, Chiba (JP); Shinji Fujikawa, Kanagawa (JP); Yutaka Myoki, Kanagawa (JP); Tatsuo Matoba, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/726,701

(22) Filed: Dec. 4, 2003

(30) Foreign Application Priority Data
Dec. 6, 2002 (JP) 2002-355842
Dec. 6, 2002 (JP) 2002-355843

(51) Int. Cl. G06F 15/00

(52) U.S. Cl. 358/1.1; 358/1.15

(57) ABSTRACT

There is provided a print service apparatus generating print setting information including a print device ID by which a print device used for previously printing can be identified when the print service apparatus has been received a print order from a user terminal and performed a print service, and controlling to display information related with the print device identified by the print device ID in a browsing window of the user terminal based on the generated print setting information. This invention prevents a printout different in tint between pages when a plurality of color pages or color copies in a single print order are assigned as print jobs for respective print copies to a plurality of printing devices in a print service provider. Further, the print service information includes a print reorder information, and the same print device as used at a previous print order is selected and the same tint as set at the previous print order is set to the same print device. Printing reordered by the user is performed by the same printing device, easily obtaining a printed material in the same tint as that of a previous order.

### FIELD OF THE INVENTION

The present invention relates to a print service method and print service apparatus and, more particularly, to a print service method and print service apparatus in a print service system which provides a print solution as one of image information providing services using the Internet without holding the print solution in the print service system, and provides the user with services in various print forms other than a home printer.

### BACKGROUND OF THE INVENTION

In recent years, the preparation of communication infrastructures and the development of information communication technology realize information providing services using the Internet. Especially, a technique of very easily providing image information providing services by using the Internet has been established. Image information can be transferred to the user, and it is becoming popular to frequently exchange image information between users.

A print service system called a print service provider provides a content provider which holds the right of image information with a content providing unit other than data download without holding any print solution in the print service system, and provides the user with services in various print forms other than a home printer.

The print service provider can use a plurality of printing devices in order to cope with large-scale printing. The print service provider can print with a plurality of printing devices in accordance with a single print order of a plurality of pages or copies.

When a plurality of color pages in a single print order are assigned as print jobs for respective pages to a plurality of printing devices in the print service provider, a printout changes in tint between pages.

When a plurality of color copies in a single print order are assigned as print jobs for respective print copies to a plurality of printing devices in the print service provider, a printout changes in tint between print copies.

In the print service system, when data which has been ordered in the past is reordered, a printer of the same type is designated, but a plurality of printers of the same type exist, the data is not always printed by the same printing device. If the reordered printout is not printed by the same printing device as the previous one, the tint changes even by a printer of the same type.

### SUMMARY OF THE INVENTION

It is an object of the present invention to prevent a printout different in tint between pages when a plurality of color pages or color copies in a single print order are assigned as print jobs for respective pages to a plurality of printing devices in a print service provider.

It is another object of the present invention to perform printing reordered by the user by using the same printing device, obtain a printout with the same tint as that of a previously ordered printout, and easily realize this.

To achieve the above objects, according to the present invention, there is provided a print service apparatus comprising generation unit adapted to generate print setting information including a print device ID by which a print device used for previously printing can be identified when the print service apparatus has been received a print order from a user terminal and performed a print service, and display control unit adapted to control to display information related with the print device identified by the print device ID in a browsing window of the user terminal based on the generated print setting information.

The print setting information includes information related with a print service provider having the print device. The information related with a print service provider contains print service information serving as a printing destination, a printer type capable of printing by the print service, or a paper size. The print setting information includes information related with print conditions set to the print device. The print conditions include tint.

The present apparatus further comprises receiving unit adapted to receive a condition for the plurality of print device, and selecting unit adapted to select the print device based on the received condition. The condition for selecting the print device shows a color printing using only a print device, and the selecting unit selects a print device.

Further, a control method of the apparatus, a control program, a storage medium storing the control program, and a system including the apparatus are provided.

According to the present invention, the user can designate the same tint for printed materials in placing a print order of a plurality of color pages or color copies. The print service provider prints with the same tint in accordance with the designated print order. In normal printing free from such designation, an optimal print solution can be realized.

According to the present invention, order information contains information on a print reorder. Printing reordered by the user is executed by the same printing device, easily obtaining a printed material in the same tint as that of a previous order.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram showing a whole system;

FIG. 2 is a block diagram showing the hardware configuration of each of a user computer, content provider computer, and data center;

FIG. 3 is a block diagram showing the hardware configuration of a print service provider computer;

FIG. 4 is a block diagram showing the software configuration of the user computer;

FIG. 5 is a block diagram showing the software configuration of each of the content provider computer and data center;

FIG. 6 is a block diagram showing the software configuration of the print service provider computer;

FIG. 7 is a view showing an example of content print information stored in a content provider computer 120;

FIG. 8 is a table showing a content provider management table;

FIG. 9 is a table showing part of an order management table;

FIG. 10 is a chart showing a processing flow between the user computer, the content provider computer, and the print service provider;

FIGS. 11A and 11B are views respectively showing an example of a content browsing window and an example of an HTML document which is transmitted from the content provider computer and is so described as to display the browsing window;

FIG. 12 is a view showing an example of a print condition designation window displayed by a document browsing unit 401 in a user computer 110;

FIG. 13 is a view showing a display example of a print confirmation window;

FIG. 14 is a schematic view showing print order information;

FIG. 15 is a flow chart showing printing by a limited printing device;

FIG. 16 is a view showing a display example of a detailed setting window for print condition designation;

FIG. 17 is a view showing the second example of the content print information stored in the content provider computer 120;

FIG. 18 is a chart showing the second processing flow between the user computer, the content provider computer, and the print service provider;

FIG. 19 is a schematic view showing the second example of the print order information;

FIG. 20 is a flow chart showing the second example of printing by a limited printing device;

FIG. 21 is a view showing another example of the print condition designation window displayed by the document browsing unit 401 in the user computer 110; and

FIG. 22 is a chart showing another example of the second processing flow between the user computer, the content provider computer, and the print service provider.

### DETAILED DESCRIPTION OF THE PREFERRED EMBODIMENTS

Preferred embodiments according to the present invention will be described in detail below.

[First Embodiment]

<System Configuration>

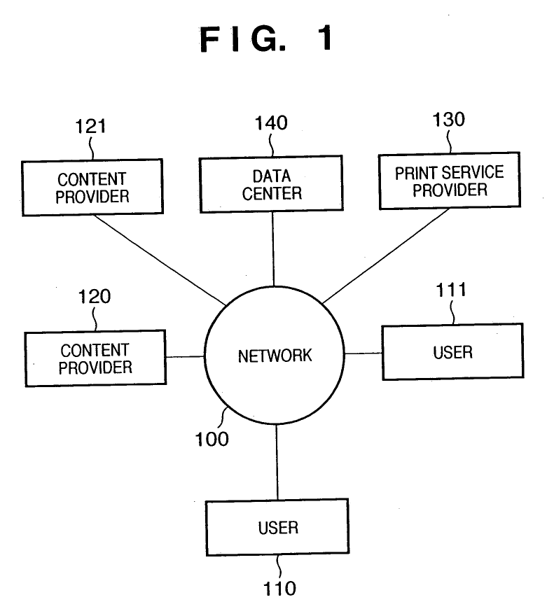

FIG. 1 is a block diagram showing a whole system according to the first embodiment of the present invention.

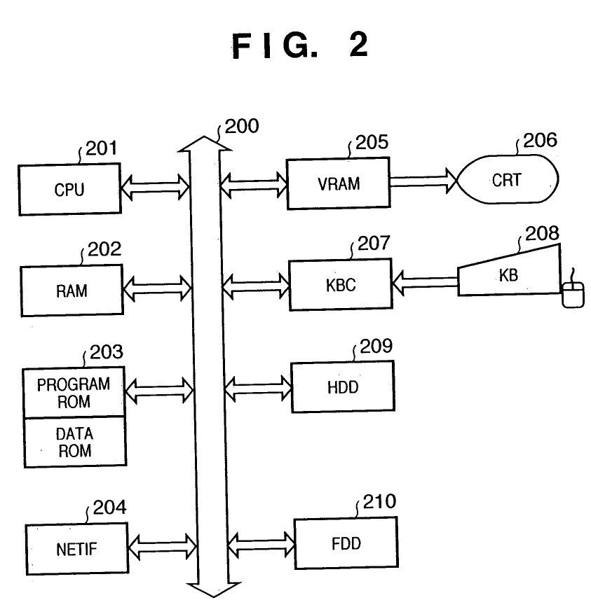

In FIG. 1, reference numerals 110 and 111 denote information processing apparatuses (computer systems each comprised of a CPU, ROM, RAM, HDD, and the like, which will be described with reference to FIG. 2) which allow direct operation at home by customers who are system users. The information processing apparatuses 110 and 111 will be referred to as user computers.

The user computers 110 and 111 have a function of browsing via a network 100 contents such as images or documents containing content catalogs which are stored in content provider computers 120 and 121 (to be described below), and a function of placing a print order with a print service provider 130 by using a print order button contained in a document. In the first embodiment, the number of connected user computers is two. However, in the first embodiment, the number of connected user computers is one or more, and the upper limit is not determined. An image print order may be referred to as a print order or simply an order.

The information processing apparatuses 120 and 121 are used for performing various services by content providers which provide contents such as documents. The information processing apparatuses 120 and 121 will be referred to as content provider computers or simply content providers.

The content provider computers 120 and 121 have a function of providing the user computers via the network 100 with contents such as documents or documents containing content catalogs (to be also referred to as content browsing windows hereinafter), and a function of supplying contents (to be also referred to as merchandise items or content entities hereinafter), accessory information, and the like to the print service provider 130 (to be described later). In the first embodiment, the number of connected content provider computers is two. However, in the first embodiment, the number of connected content provider computers is one or more, and the upper limit is not determined. In the first embodiment, one content provider business entity operates one content provider computer for descriptive convenience. However, in the first embodiment, the content provider business entity may operate two or more content provider computers for the purpose of distribution of the access load, processing of different contents, and the like.

The information processing apparatus 130 mainly performs print processing on the basis of a request from the user computer 110 or 111. The information processing apparatus 130 will be referred to as a print service provider computer or simply a print service provider.

The print service provider 130 has a function of supplying a document for realizing a print order window on the basis of a request from the user computer 110 or 111, receiving print settings in the window, forming a print order, acquiring contents from the content provider computer 120 or 121 or a data center computer 140 (to be described later) in accordance with the print order, and performing print processing.

In the first embodiment, one print service provider business entity operates one print service provider computer for descriptive convenience. However, in the first embodiment, the print service provider business entity may operate two or more print service provider computers for the purpose of load distribution and the like.

The information processing apparatus 140 stores a content entity and the like described in a document containing content catalog pages laid open to the public in the content provider computer 120 or 121. The information processing apparatus 140 will be referred to as a data center computer or data center.

When the user browses a content browsing window serving as a content catalog in the content provider computer 120 or 121, and places a print order of a content entity in the browsing window with the print service provider computer 130, the data center computer 140 transmits to the print service provider computer 130 the content entity requested by the print service provider 130, and data such as content print information (to be described later) necessary for printing and a print order.

In the first embodiment, the number of connected data centers is one. However, the first embodiment does not limit the number of connected data centers.

In the first embodiment, one data center business entity operates one data center computer for descriptive convenience. However, in the first embodiment, the data center business entity may operate two or more data center computers for the purpose of load distribution and the like.

The connection apparatus 100 connects the user computers 110 and 111, content provider computers 120 and 121, print service provider computer 130, and data center computer 140. The connection apparatus 100 represents a network system such as the Internet or a local area network (LAN), and will be simply referred to as a network. The network 100 uses the general Internet in the first embodiment, but this embodiment can also be realized using another network system.

The first embodiment assumes that the content provider computer 120 has a content entity to be printed. The content provider computer 121 has a content catalog window, and the data center 140 stores information necessary for printing and a print order, such as a content entity and content print information serving as content accessory information (to be described later). The user can place a print order on the content browsing window of the content provider computer 121.

<Block Diagram of User Computer, Content Provider Computer, and Data Center>

FIG. 2 is a block diagram showing the hardware configuration of each of the information processing apparatuses according to the first embodiment. In the first embodiment, the internal arrangements of the user computers 110 and 111, content provider computers 120 and 121, and data center computer 140 are almost the same, and will be explained at once with reference to FIG. 2.

In FIG. 2, reference numeral 201 denotes a central processing unit (to be referred to as a CPU hereinafter) which controls the information processing apparatus.

Reference numeral 202 denotes a random access memory (to be referred to as a RAM hereinafter) which functions as a main memory for the CPU 201, an area for an executing program, and an executing area and data area for the program.

Reference numeral 203 denotes a read only memory (to be referred to as a ROM hereinafter) which stores the operation processing sequence of the CPU 201. The ROM 203 includes a program ROM which records an OS (Operating System) serving as a system program for controlling devices of the information processing apparatus, and a data ROM which records, e.g., information necessary for operating the system. The ROM 203 may be replaced with an HDD 209 (to be described later).

Reference numeral 204 denotes a network interface (NETIF) which performs control of transferring data between information processing apparatuses via a network, and diagnoses a connection status.

Reference numeral 205 denotes a video RAM (VRAM) which maps an image that is to be displayed on the screen of a CRT 206 (to be described later) and represents the operating state of the information processing apparatus, and which controls the display of the image.

The display device 206 is, e.g., a display, and will be referred to as a CRT hereinafter.

Reference numeral 207 denotes a controller for controlling an input signal from an external input device 208 (to be described below).

The external input device 208 receives an operation by the user of the information processing apparatus to the information processing apparatus. The external input device 208 is, e.g., a keyboard or a pointing device such as a mouse, and will be simply referred to as a KB hereinafter.

The HDD (Hard Disk Drive) 209 is used to save an application program, and data such as image information. The application program in the first embodiment is, e.g., a software program which executes various processing unit that constitute this embodiment.

Reference numeral 210 denotes an external input/output device to/from which a removable disk such as a flexible disk drive or CD-ROM drive is loaded/unloaded. The external input/output device 210 is used to read out the above-mentioned application program from a medium. The external input/output device 210 will be simply referred to as an FDD hereinafter.

The application program and data which are stored in the HDD 209 can also be stored in the FDD 210 and used.

Reference numeral 200 denotes an input/output bus (address bus, data bus, and control bus) for connecting the above-described units.

<Block Diagram of Print Service Provider Computer>

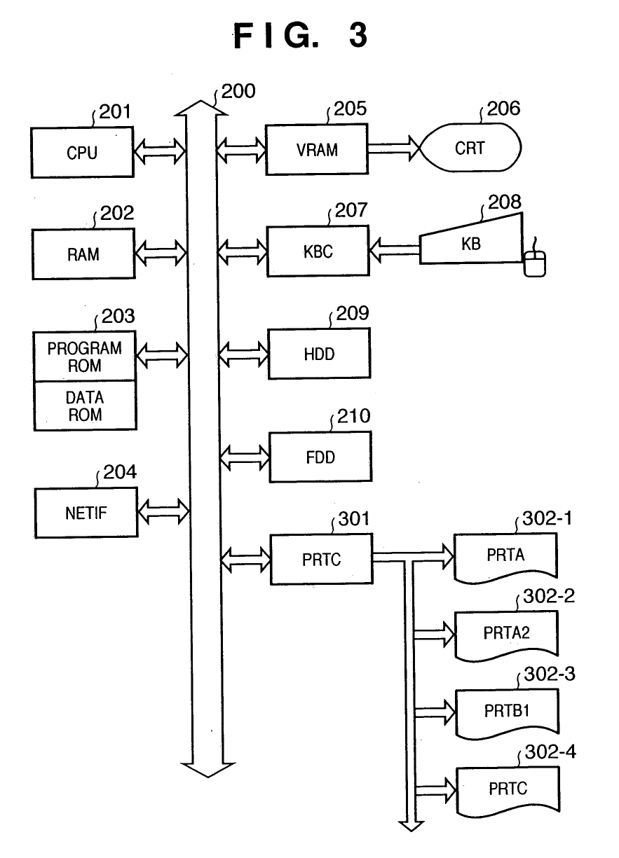

FIG. 3 is a block diagram showing the hardware configuration of the print service provider computer 130 according to the first embodiment. The print service provider computer 130 has several units in addition to the same hardware configuration as those of the user computers 110 and 111, content provider computers 120 and 121, and data center computer 140 which have been described with reference to FIG. 2. Also in FIG. 3, the same reference numerals as those in FIG. 2 denote the same building components.

In FIG. 3, reference numeral 201 denotes a CPU which controls an information processing apparatus serving as the service provider computer 130.

Reference numeral 202 denotes a RAM which functions as a main memory for the CPU 201, an area for an executing program, and an executing area and data area for the program.

Reference numeral 203 denotes a ROM which stores the operation processing sequence of the CPU 201. The ROM 203 includes a program ROM which records an OS (Operating System) serving as a system program for controlling devices of the print server, and a data ROM which records, e.g., information necessary for operating the system. The ROM 203 may be replaced with an HDD 209 (to be described later).

Reference numeral 204 denotes a network interface (NETIF) which performs control of transferring, via a network, data to another information processing apparatus connected to the network such as the user computer 110, and diagnoses a connection status.

Reference numeral 205 denotes a VRAM which maps an image that is to be displayed on the screen of a CRT 206 (to be described later) and represents the operating state of the information processing apparatus, and which controls the display of the image.

The display device 206 is, e.g., a display, and will be referred to as a CRT hereinafter.

Reference numeral 207 denotes a controller for controlling an input signal from an external input device 208 (to be described below).

The external input device 208 receives an operation by the user of the information processing apparatus to the information processing apparatus. The external input device 208 is, e.g., a keyboard or a pointing device such as a mouse, and will be simply referred to as a KB hereinafter.

The HDD (Hard Disk Drive) 209 is used to save an application program for controlling printing, and data such as image information.

Reference numeral 210 denotes an external input/output device to/from which a removable disk such as a flexible disk drive or CD-ROM drive is loaded/unloaded. The external input/output device 210 is used to read out the above-mentioned application program from a medium. The external input/output device 210 will be simply referred to as an FDD hereinafter.

The application program and data which are stored in the HDD 209 can also be stored in the FDD 210 and used.

Reference numeral 301 denotes a printer control device which controls an external output device 302 (to be described below) and an image to be output. The printer control device 301 will be referred to as a PRTC hereinafter. A plurality of PRTCs may be adopted as far as they are connected via a network. The PRTCs may be a plurality of print shops which provide print services.

The external output device 302 is, e.g., a printing device which will be referred to a PRT hereinafter. A plurality of printing devices 302 are connected to the PRTC 301.

The PRTC may be connected to a plurality of printing devices 302 of the same type in order to cope with large-scale printing. For example, as for a printer type PRTA, PRTA corresponds to 302-1; and PRTA2, to 302-2. In practice, two or more PRTs which can be controlled by the PRTC can be connected.

The PRTC may be connected to a plurality of printing devices 302 of different types in order to cope with various print forms. In FIG. 3, printer types PRTA, PRTB1, and PRTC correspond to 302-1, 302-3, and 302-4, respectively. In practice, the number of PRTs which can be controlled by the PRTC can be connected.

Reference numeral 200 denotes an input/output bus (address bus, data bus, and control bus) for connecting the above-described units.

As described above, the print service provider computer 130 in the first embodiment is assumed to be connected to a printer.

In the first embodiment, when a printer or another computer connected to a printer is connected to the network 100, and the printer can be used to print a print order received by the print service provider computer 130, the configuration of the print service provider computer 130 can be realized by the same configuration as those of the above-described user computers 110 and 111 or content provider computers 120 and 121 without any printer.

<Configuration of User Computer>

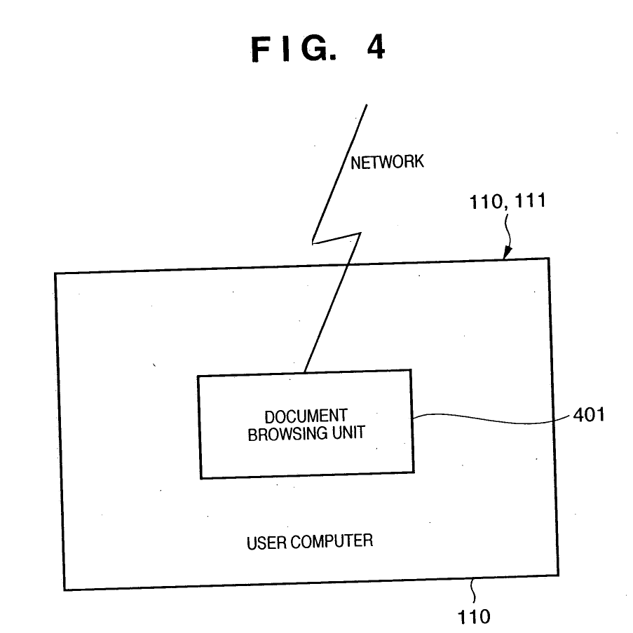

FIG. 4 is a block diagram for explaining the software configuration of the user computer 110 serving as an information processing apparatus which is actually used by the user. The user computer 111 also has the same arrangement.

The user computer 110 comprises a document browsing unit 401 serving as an application program which is loaded from the ROM 203, HDD 209, or FDD 210, mapped in the RAM 202, and used. The document browsing unit 401 is an application program (so-called general application program such as an Internet browser) which can receive a service from the outside such as the Internet via a network. Services which are generally received by the document browsing unit 401 are documents described in the HTML (HyperText Markup Language). In addition to document browsing, the document browsing unit 401 can issue a document transmission request to the content provider computer 120 or 121 or print service provider computer 130 with a button embedded in the HTML, transmit a print request, and transmit various settings such as paper size in the print request that are set in the user computer.

<Configurations of Content Provider Computer and Data Center Computer>

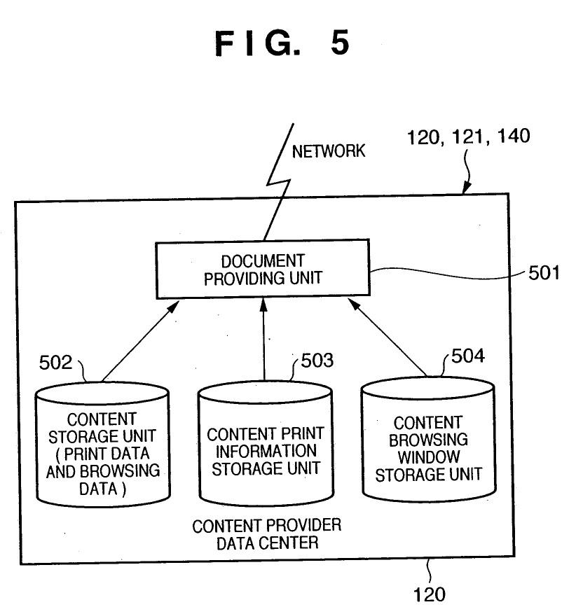

FIG. 5 is a block diagram showing each processing unit and management data in the content provider computer 120. The content provider computer 121 and data center computer 140 have almost the same configurations, and will be explained with reference to FIG. 5.

In FIG. 5, reference numeral 501 denotes an application program which is loaded from the ROM 203, HDD 209, or FDD 210, mapped in the RAM 202, and used. Reference numerals 502, 503, and 504 denote data which are stored in the HDD 209.

The document providing unit 501 is an application program which can search data stored in the HDD 209 (to be described later) for an HTML document, text, image, or the like requested by an external computer such as the user computer 110 or 111 or print service provider computer 130 via a network such as the Internet, and transmit the searched data. The document providing unit 501 is a generally called Internet server program or WWW server program. The document providing unit 501 is an application program which can map in the RAM 202 an application program stored in the HDD 209 or the like and use the mapped program in response to a request from an external computer, and if necessary, authenticate the user ID of the user in response to an external request to limit data to be transmitted, in addition to document transmission.

The content storage unit 502 stores a content entity such as an image or document to be printed in the print service provider 130, and browsing data for a content preview display in the user computer. Browsing data is an image obtained by decreasing the resolution to a degree enough to display a window for an image. For a document, an image enough to display an abstract text or first page in a window is used. Note that the first embodiment does not particularly define browsing data.

Data in the unit 502 is stored in the HDD 209. The document providing unit 501 searches the unit 502, and transmits the searched data in response to a request from an external computer such as the user computer 110 or 111 or print service provider computer 130.

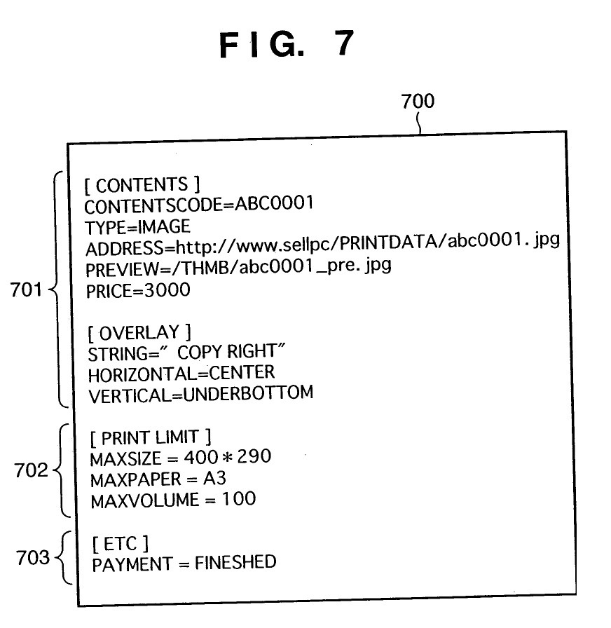

The content print information storage unit 503 stores content print information which describes various limitations on a content such as the print size and the number of print copies in printing a content entity stored in the content storage unit 502, various limitations on print conditions such as the print paper size and print quality, and information necessary for a print order and print processing. Details of content print information will be described with reference to FIG. 7.

Data in the unit 503 is stored in the HDD 209. The document providing unit 501 searches the unit 503, and transmits the searched data in response to a request from an external computer such as the print service provider computer 130.

The content browsing window storage unit 504 stores an HTML document for browsing in the user computer 110 or 111 content browsing data stored in the content storage unit 502, and displaying a print request window (content browsing window).

Data in the unit 504 is stored in the HDD 209. The document providing unit 501 searches the unit 504, and transmits the searched data in response to a request from an external computer such as the user computer 110 or 111.

The configuration of the content provider computer 120 has been described. In the first embodiment, the content provider computer 121 does not always require the content print information storage unit 503 and content storage unit 502 because content print information and a content entity are processed on the assumption that they exist in the data center computer 140. In this case, content browsing data may be the content browsing window storage unit 504. In the data center computer 140, the document providing unit 501 need not be a so-called WWW server, and may use, e.g., an FTP (File Transfer Protocol) server capable of transmitting a file to the print service provider computer 130. In realizing the first embodiment, the content browsing window storage unit 504 in the data center computer 140 is not indispensable.

<Configuration of Print Service Provider Computer>

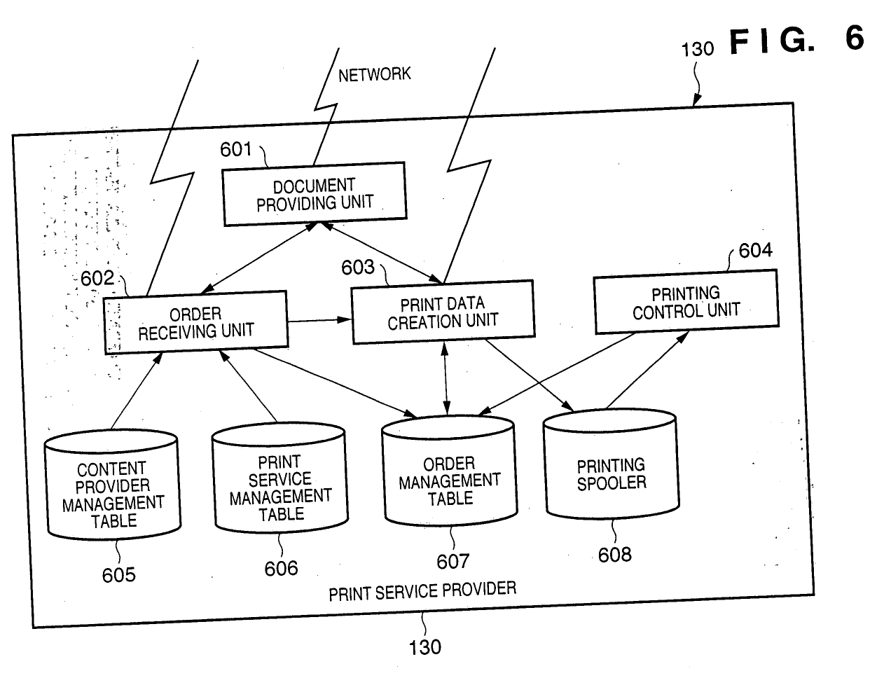

FIG. 6 is a block diagram showing each processing unit and management data in the print service provider computer 130. In FIG. 6, processing units 601, 602, 603, and 604 are application programs which are loaded from the ROM 203, HDD 209, or FDD 210, mapped in the RAM 202, and used. Reference numerals 605, 606, 607, and 608 denote data which are stored in the HDD 209.

The document providing unit 601 is equivalent to the document providing unit 501. The document providing unit 601 is an application program which can search data stored in the HDD 209 (to be described later) for an HTML document, text, image, or the like requested by an external computer such as the user computer 110 or 111 or content provider computer 120 or 121 via a network such as the Internet, and transmit the searched data. The document providing unit 601 is a generally called Internet server program or WWW server program. The document providing unit 601 is an application program which can map in the RAM 202 an application program stored in the HDD 209 or the like and use the mapped program in response to a request from an external computer, and if necessary, authenticate the user ID of the user in response to an external request to limit data to be transmitted, in addition to document transmission.

The order receiving unit 602 is an application program group which receives a print order of a content.

The functions of the order receiving unit 602 can be roughly classified into three stages. The first stage is a function which is activated by a print order request issued by the user computer 110 or 111, specifies a content provider having a print-requested content and the content, acquires from the content provider computer 120 or data center computer 140 content print information of the content necessary to receive an order, acquires necessary information from the print service management table 606 (to be described later), generates order information in the order management table 607 (to be described later), also generates an HTML document in order to display a print condition designation window for performing various settings in printing, and transmits the HTML document to the user computer 110 or 111 which has issued the print order request.

The second stage is a function which is activated by a print condition setting request issued at the same time as setting of various print conditions in accordance with a print condition window displayed in the user computer 110 or 111 serving as the HTML document transmission destination, generates a print order, and transmits an HTML document in order to display a print confirmation window in the user computer.

The third stage is a function which is activated by performing confirmation operation in the print confirmation window and receiving a print order completion notification issued from the user computer 110 or 111, and activates the print data creation unit 603 (to be described later) for performing print preparation work.

As described above, the order receiving unit 602 is an application program which is mapped in the RAM 202 from the HDD 209 or the like and used by the document providing unit 601 on the basis of a request from an external computer. The order receiving unit 602 is generally called a CGI program.

The print data creation unit 603 is an application program which is mapped in the RAM 202 from the HDD 209 or the like and used by the order receiving unit 602.

The print data creation unit 603 is activated by the order receiving unit 602, and extracts a record subjected to print data creation from the order management table 607. The print data creation unit 603 acquires a content entity to be printed from the content provider computer 120 or data center computer 140 in accordance with the record. The print data creation unit 603 creates data necessary for printing, and stores the resultant data in the printed material spooler 608 (to be described later).

The printing control unit 604 controls print processing of print data in the printed material spooler 608 in accordance with the order management table 607. The printing control unit 604 is an application program which is mapped in the RAM 202 from the HDD 209 or the like and used.

The printing control unit 604 transfers print data to the printer control device 301, and causes the printer device 302 to print.

The printing control unit 604 is activated in response to activation of the print data creation unit 603, at an arbitrary timing by the operator of the print service provider computer 130, or automatically at a predetermined interval based on the timer.

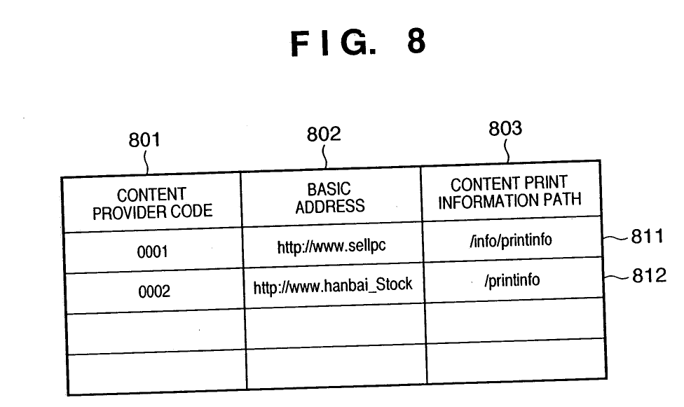

The content provider management table 605 has a data structure in FIG. 8 (to be described later). The content provider management table 605 stores the address of the content provider computer or data center, the address of content print information, and the like.

<Print Service Information>

Print service information stored in the print service management table 606 of the print service provider computer 130 will be explained.

Print service information is information which describes data necessary for the print service provider computer 130 in printing.

The print service management table 606 is a table which stores all print service settings provided by the print service provider computer 130. The print service management table 606 stores the printer model, printer device ID, print conditions (layout information (e.g., paper size, the number of copies, paper quality, quality, position, enlargement/reduction, double-sided printing, and binding direction) and processing information (e.g., bookbinding after printing, lamination, and framing)), print cost information, and the like.

A printer registered in the print service management table 606 must be one which can execute print processing in accordance with a print order received by the print service provider computer 130. As for printer connection, the printer can be one connected to the PRTC 301 of the print service provider computer 130, and also one directly connected to the network 100 or one connected to a computer other than the print service provider computer 130 connected to the network 100.

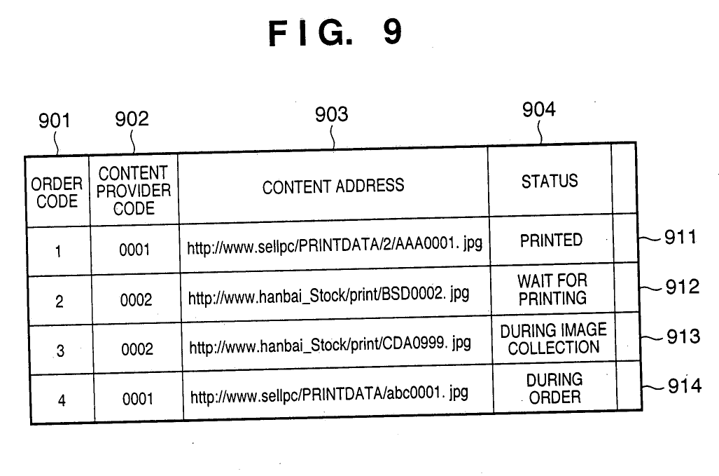

The order management table 607, details of which will be described with reference to FIG. 9, stores a print order, its accessory information, and the progress of the order.

The printed material spooler 608 stores a content entity which realizes printing of a print order, and data necessary for printing.

<Content Print Information>

Content print information stored in the content print information storage unit 503 of the content provider computer 120 and data center computer 140 will be explained.

As described above, content print information is data which describes a print order and information necessary for print processing in printing a content of the content provider. As for the data format, the first embodiment does not specify a specific data format or description format. A content which is stored in the content storage unit 502 and can be printed in the first embodiment must have content print information corresponding to the content. Also, the first embodiment does not particularly limit a method of transferring content print information to the print service provider. In the first embodiment, for clearer description, one text file which describes content print information is stored in the content print information storage unit 503 in correspondence with one printable content.

As information on a content out of information described in content print information, the following pieces of information are described as needed.

\mathring{1} a content code which allows uniquely specifying a content within the range of at least the content provider

\mathring{2} a content type such as a document or image.

\mathring{3} the address of a content entity

\mathring{4} the address of browsing data

\mathring{5} cost information

\mathring{6} overlay information which is information to be overlaid in printing a content, such as a copyright notice or serial number

\mathring{7} overlay position information representing the overlay position of the overlay information

As information such as limitations on content printing, the following pieces of information are described as needed.

\mathring{1} size limitation information which limits, e.g., the minimum and maximum sizes of a content in printing

\mathring{2} paper size limitation information which limits the size of print paper

\mathring{3} paper quality limitation information which limits the paper quality of print paper

\mathring{4} number-of-print-copies limitation information which limits the maximum number of print copies

\mathring{5} printer limitation information which limits a printer model for printing

In addition, content print information describes the following pieces of information, as needed.

\mathring{1} default designation of print setting

\mathring{2} content payment information

\mathring{3} printed material payment information

\mathring{4} user identification information

\mathring{5} print order identification information managed by the content provider

FIG. 7 is a view showing an example of content print information in the first embodiment.

In FIG. 7, reference numeral 700 denotes content print information which is supplied by a text data file in the first embodiment. As shown in FIG. 7, the content print information 700 starts with a header item surrounded by “[ ]”, and describes “setting name=setting value” subsequent to the header item.

Reference numeral 701 denotes a content information column which describes information on a content. There are two header items representing the content information column 701 in the first embodiment. The first header item “[CONTENTS]” describes a content code and the like. The second header item “[OVERLAY]” describes an overlay character string to be printed together with a content by overlay in printing the content, and the overlay position of the overlay character string. In FIG. 7, the first header item contains five settings.

“CONTENTSCODE=ABC0001” represents that the target of the content print information 700 is a content specified by a content code “ABC0001”.

“TYPE=IMAGE” represents a content type such as a content image or document, and suggests that “ABC0001” is an image.

“ADDRESS=http://www.sellpc/PRINTDATA/abc0001.jpg” represents that the address of a file “abc0001.jpg” serving as a content entity is “http://www.sellpc/PRINTDATA/abc0001.jpg”.

“PREVIEW=/THMB/abc0001_pre.jpg” represents that the address of browsing data “abc0001_pre.jpg” used for preview or the like is “/THMB/abc0001_pre.jpg”. Unlike the content entity, information representing a computer name is not described at the address of browsing data. This unit that the browsing data exists in the computer which stores the content print information 700.

The final setting “PRICE=3000” belonging to the header item “[CONTENTS]” represents that the content price is ¥3,000. The currency unit is omitted in the first embodiment, but may be described in consideration of the presence of a plurality of currency units.

The other header item “[OVERLAY]” of the content information column 701 describes additional data to be printed together with a content in printing the content, and the overlay position of the additional data.

“STRING=“COPY RIGHT”” is a character string in which a character string surrounded by “ ” at the setting value is printed together with a content. “HORIZONTAL=CENTER” and “VERTICAL=UNDERBOTTOM” define the overlay position of the additional data, and in FIG. 7, mean that the horizontal position is the center and the vertical position is the underbottom.

Reference numeral 702 denotes a print information column which describes limitation information in printing a content.

The print information column 702 in the first embodiment is represented by a header item “[PRINT LIMIT]”.

In FIG. 7, the header item “[PRINT LIMIT]” contains the following three setting items. Items other than the three items shown in FIG. 7 can also be set in the content print information. In the first embodiment, information whose setting is omitted is free from any limitation, or uses a default value prepared in advance in the print service provider computer 130.

“MAXSIZE=400*290” represents that the actual print size of a content is limited to a width of 400 (mm) and a height of 290 (mm).

“MAXPAPER=A3” represents that the maximum paper size available in printing is limited to A3.

“MAXVOLUME=100” represents that the number of print sheets by one print order is limited to 100.

Reference numeral 703 denotes a miscellaneous information column which describes miscellaneous information belonging to neither information on a content nor limitation information on content printing out of content print information in the first embodiment. The information column 703 in the first embodiment is expressed by a header item “[ETC]”.

“PAYMENT=FINISHED” in FIG. 7 represents that the use charge of a content has already been paid.

Content print information in the first embodiment has been described with reference to FIG. 7. Note that a description of omissible information can be omitted not only from the print information column 702 but also from the content information column 701 and information column 703 unless omission poses a problem in a print order and printing.

<Content Provider Management Table>

The content provider management table 605 of the print service provider computer 130 will be explained.

The content provider management table 605 stores and manages the existing positions of the content provider computer 120 and data center computer 140 and the storage positions of pieces of content print information in the computers. This table is stored in the HDD 209. The use of a database system or the like can provide a more preferable arrangement.

The content provider management table 605 is searched when the order receiving unit 602 performs order receiving processing. Print order receiving processing for a content present in an external computer can be done by referring to the search result.

FIG. 8 is a table showing the content provider management table in the first embodiment.

The content provider management table 605 manages three items 801, 802, and 803 as one record (to be referred to as a content provider management record hereinafter).

The content provider code 801 is generated and stored in advance for each content provider in order to specify the content provider.

The basic address 802 represents the existing positions of the content provider computers 120 and 121 in the network. In the first embodiment, the basic address 802 describes an existing position by the URL (Uniform Resource Locations) generally used in the Internet environment in order to explain a network connection example using the Internet.

The content print information path 803 stores the position of the content print information storage unit 503. The content print information path 803 is described by a relative path from the basic address 802.

With this structure, a content provider code is specified from a parameter supplied in activating the order receiving unit. A file name is added to content print information so as to guarantee oneness by the content code. The basic address 802 and content print information path 803 in the record which is searched on the basis of the content provider code 801 are synthesized, and the content print information file name is further synthesized. The existing position of content print information subjected to a print order can therefore be specified. The content print information is acquired from the specified existing position of the content print information in the content provider computer 120 or data center computer 140.

A data example of the content provider management table in the first embodiment will be explained.

Reference numeral 811 denotes a content provider management record corresponding to the content provider computer 120 in the first embodiment. The content provider management record 811 represents that the content provider code 801 generated in advance is “0001”, the basic address 802 is “http://www.sellpc”, and the content print information path 803 is “/info/printinfo”.

Reference numeral 812 denotes a content provider management record corresponding to the content provider computer 121 in the first embodiment. The content provider management record 812 represents that the content provider code 801 generated in advance is “0002”, the basic address 802 is “http://www.hanbai_Stock” exhibiting the data center 140, and the content print information path 803 is “/printinfo”.

A concrete example of a sequence of generating a content print information position by the order receiving unit 602 in the print service provider computer 130 having the content provider management records 811 and 812 will be explained.

When the order receiving unit 602 is activated, it analyzes parameters transferred upon activating the unit 602. For example, when the analysis results of the parameters transferred upon activation are a content provider code “0001” and content code “ABC0001”, the order receiving unit 602 specifies the content provider management record 811 by searching for a content provider record whose content provider code 801 in the content provider management table 605 coincides with “0001”. Subsequently, the order receiving unit 602 acquires the content provider management record 811, and synthesizes the basic address 802, content print information path 803, and content code into the path of content print information corresponding to a content subjected to a print order. For example, when a file extension “.inf” is added to a content code as a content print information file name, the existing position of the content print information of the content specified by the content code “ABC0001” is “http://www.sellpc/info/printinfo/ABC0001.inf”.

<Order Management Table>

The order management table 607 in the print service provider computer 130 will be explained.

The order management table 607 manages the address of a content to be printed in accordance with a print order, information necessary for printing, the progress of the print order, and the like. This table is stored in the HDD 209. The use of a database system or the like can provide a more preferable arrangement in realizing the first embodiment.

FIG. 9 is a table showing part of the order management table 607.

The order management table 607 forms one record for one order.

Reference numeral 901 denotes an order code which can uniquely specify a print order to the print service provider computer 130. The order code 901 is generated upon activating the order receiving unit 602, and used to specify an order in processing by the order receiving unit 602, print data creation unit 603, and printing control unit 604.

Reference numeral 902 denotes a content provider code which stores the code of a content provider having a content to be printed in accordance with a print order. The content provider code 902 is obtained by analyzing a parameter transferred upon activating the order receiving unit 602, and stored together with an order code upon generating the order code.

Reference numeral 903 denotes a content address for storing the address of a content entity in an external computer such as the content provider computer 120 or data center 140 serving as the collecting destination of a content entity to be printed in accordance with a print order. When the order receiving unit acquires content print information from the content provider computer 120 or data center 140, the content address 903 is extracted from the content print information and stored.

Reference numeral 904 denotes a status which manages the progress of a print order. In the first embodiment, the following statuses are stored as the progress in the status 904.

\mathring{1} “during order” as a print order receiving stage

\mathring{2} “during image collection” representing that print data is being created by the print data creation unit 603

\mathring{3} “wait for printing” as a state in which pieces of information such as a content necessary for printing are stored in the printed material spooler 608 and print preparations are completed

\mathring{4} “printed” representing that printing has been done by the printing control unit 604

The record structure of the order management table 607 necessary for the description of the first embodiment has been explained. In addition to the data 901, 902, 903, and 904, one record of the order management table 607 stores information on printing and a print order, such as the output printer, paper size, paper quality, orderer, and payment information. Note that the first embodiment does not limit separation of elements forming one record of the order management table 607 according to this embodiment into a plurality of tables such that information on print data such as the content address 903 and information not directly concerning printing such as the orderer of a print order are separated in different tables, or the progress of an order is also separated.

Referring back to FIG. 9, reference numerals 911, 912, 913, and 914 denote record examples of the order management table. These record examples such as the “order management record example 911” are used in the first embodiment.

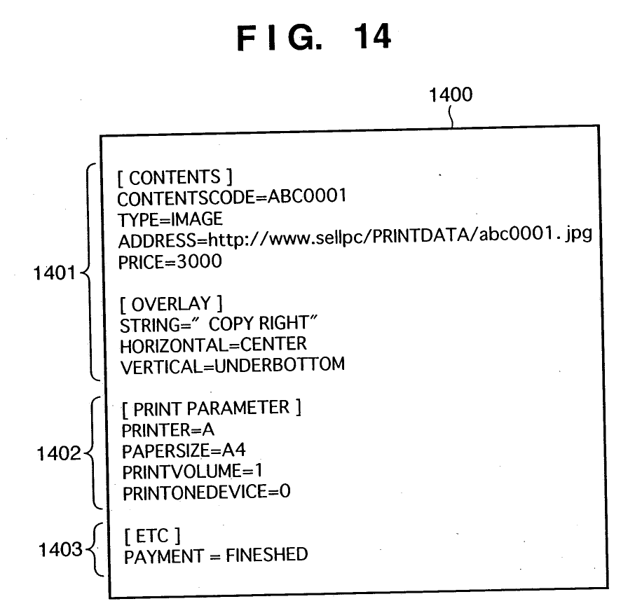

FIG. 14 is a schematic view showing print order information associated with the record 914.

In FIG. 14, reference numeral 1400 denotes print order information which is supplied by a text data file and associated with the database record 914 in the first embodiment. Similar to content print information, the print order information 1400 starts with a header item surrounded by “[ ]”, and describes “setting name=setting value” subsequent to the header item, as shown in FIG. 14.

Reference numeral 1401 denotes a content information column which describes information on a content. There are two header items representing the content information column 1401 in the first embodiment. The first header item “[CONTENTS]” describes a content code and the like. The second header item “[OVERLAY]” describes an overlay character string to be printed together with a content by overlay in printing the content, and the overlay position of the overlay character string. In FIG. 14, the first header item contains four settings. The content information column allows setting the same items as those of the content information column 701 in content print information. An order creation unit 505 in the content provider computer 120 generates this column from content print information.

“CONTENTSCODE=ABC0001” represents that the target of the content print information 1400 is a content specified by a content code “ABC0001”.

“TYPE=IMAGE” represents a content type such as a content image or document, and suggests that “ABC0001” is an image.

“ADDRESS=http://www.sellpc/PRINTDATA/abc0001.jpg” represents that the address of a file “abc0001.jpg” serving as a content entity is “http://www.sellpc/PRINTDATA/abc0001.jpg”.

The final setting “PRICE=3000” belonging to the header item “[CONTENTS]” represents that the content price is ¥3,000. The currency unit is omitted in the first embodiment, but may be described in consideration of the presence of a plurality of currency units.

The other header item “[OVERLAY]” of the content information column 1401 describes additional data to be printed together with a content in printing the content, and the overlay position of the additional data. “STRING=“COPY RIGHT”” represents additional data. A character string surrounded by “ ” at the setting value is a character string to be printed together with a content. “HORIZONTAL=CENTER” and “VERTICAL=UNDERBOTTOM” define the overlay position of the additional data, and in FIG. 14, mean that the horizontal position is the center and the vertical position is the underbottom.

Reference numeral 1402 denotes a print setting information column which describes print conditions set on the basis of print service information transmitted from the print service provider computer 130 to the content provider computer 120.

The print setting information column 1402 in the first embodiment is represented by a header item “[PRINT PARAMETER]”.

In FIG. 14, the header item “[PRINT PARAMETER]” contains the following four setting items. The print setting information column 1402 also allows setting items such as double-sided printing designation and print quality in addition to the four setting items shown in FIG. 14. In the first embodiment, information whose setting is omitted is free from any limitation, or uses a default value prepared in advance in the print service provider computer 130.

“PRINTER=A” represents that the printer type used for printing is “A”.

“PAPERSIZE=A4” represents that the paper size used for printing is A4.

“PRINTVOLUME=1” represents that the number of print sheets is one.

“PRINTONEDEVICE=0” represents that the number of printing devices is limited to one.

Reference numeral 1403 denotes a miscellaneous information column which describes miscellaneous information belonging to neither information on a content nor limitation information on content printing out of content print information in the first embodiment. The information column 1403 in the first embodiment is expressed by a header item “[ETC]”.

“PAYMENT=FINISHED” in FIG. 14 represents that the use charge of a content has already been paid.

Content print information in the first embodiment has been described with reference to FIG. 14. Note that a description of omissible information can be omitted not only from the print setting information column 1402 but also from the content information column 1401 and information column 1403 unless omission poses a problem in a print order and printing.

<Processing Flow in System>

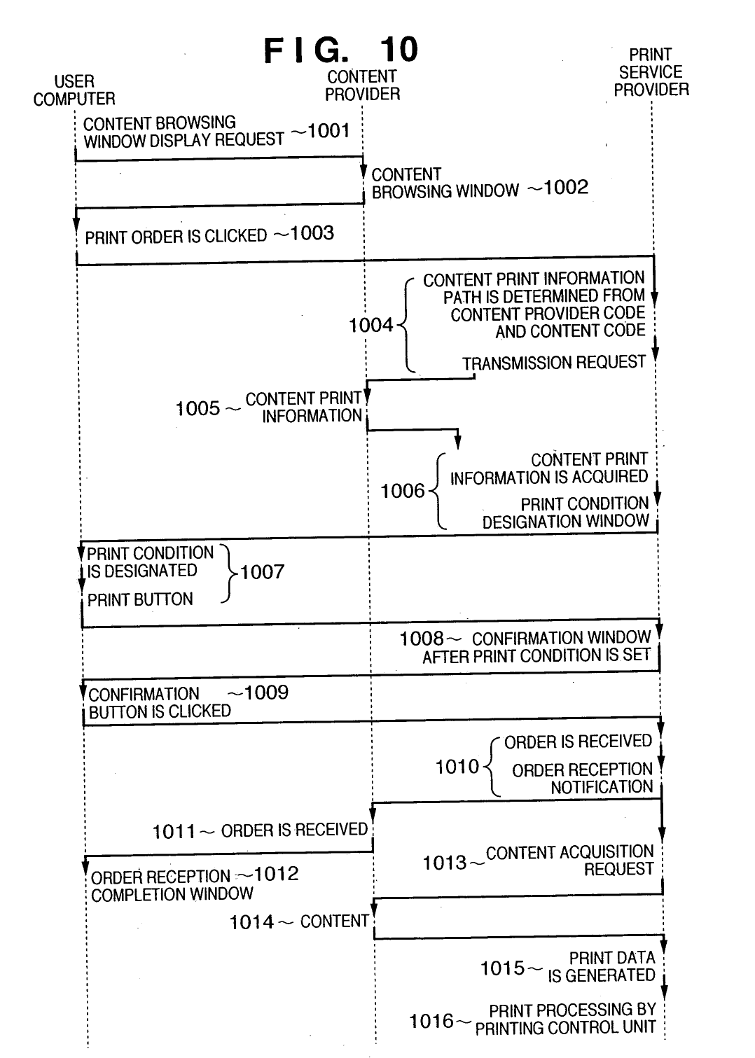

A processing flow in the first embodiment will be explained with reference to FIG. 10 and other drawings.

FIG. 10 is a chart for explaining a processing flow between the user computer 110, the content provider computer 120, and the print service provider 130 in the first embodiment. In the following description, the user browses a content browsing window in the content provider 120 by using the user computer 110, and places a print order with the print service provider 130.

The user issues a content browsing window display request to the content provider computer 120 by using the document browsing unit 401 in the user computer 110. The content browsing window display request designates the URL of a content browsing window desired by the user on the basis of the HTTP protocol. The URL is designated by directly inputting it to the document browsing unit 401 by the user using the KB 208, or selecting the link of a window to be displayed by the document browsing unit 401 on the basis of the HTML document (1001).

The content browsing window display request issued by the user computer 110 is received through the NETIF 204 by the document providing unit 501 in the content provider computer 120 via the network 100. The document providing unit 501 which has received the content browsing window display request transmits, to the user computer 110 which has issued the request, an HTML document which corresponds to the designated URL and is stored in the content browsing window storage unit 504, and browsing data which is linked to the document and stored in the content storage unit 502 (1002).

The document browsing unit 401 in the user computer 110 that has received the HTML document and browsing data displays a content browsing window on the basis of the HTML document.

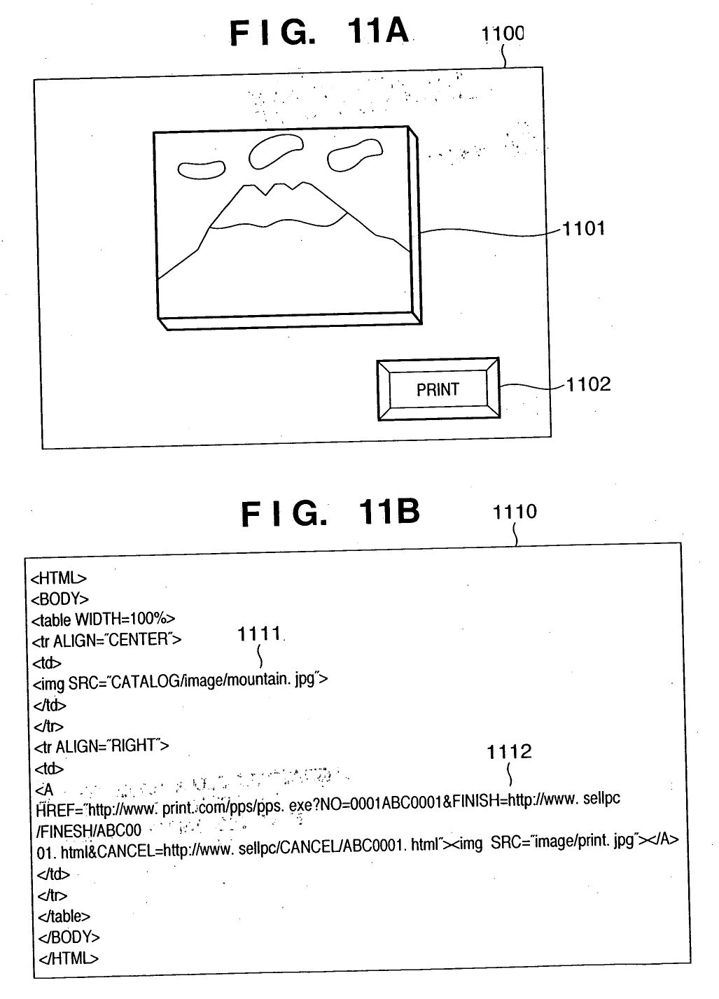

The content browsing window will be explained with reference to FIGS. 11A and 11B.

FIG. 11A shows the content browsing window. FIG. 11B shows an example of the HTML document which is transmitted from the content provider computer 120 and is so described as to display the browsing window.

In FIG. 11A, reference numeral 1100 denotes a content browsing window which is displayed in the user computer 110 in the first embodiment.

Reference numeral 1101 denotes a browsing image using content browsing data displayed in the window. The content browsing data is transmitted from the content storage unit 502 in the content provider computer 120, and displayed in the window by the document browsing device 401.

Reference numeral 1102 denotes a print request button for issuing a print request for a content displayed in the window to the print service provider computer 130.

In FIG. 11B, reference numeral 1110 denotes an HTML document which describes, e.g., the display form and link of the content browsing window 1100.

Reference numeral 1111 denotes a browsing display directive which is so described as to display a browsing image. The browsing display directive 1111 describes the existing position and image file name of browsing data in the first embodiment.

Reference numeral 1112 denotes a print button display/operation directive which is so described as to display a print button, and describes an operation instruction to the document browsing unit 401 when an operation instruction is issued by, e.g., clicking the print button. A description “http://www.print.com/pps/pps.exe” in the print button display/directive is an activation instruction for a CGI program serving as the order receiving unit 602 to the service provider computer 130. “NO=0001ABC001” is the first parameter upon activating the order receiving unit 602. A plurality of parameters can be designated by “&”, and the second parameter is “FINISH=http://www.sellpc/FINISH/ABC0001.html”. Similarly, the third parameter is “CANCEL=http://www.sellpc/CANCEL/ABC0001.html”. The first parameter in the first embodiment is formed by a content provider code stored in the content provider code 801 of the content provider management table 605, and a content code stored in the content print information 700. The second and third parameters represent return destinations to windows provided by the content provider after the end of order receiving processing. The second parameter represents a return destination when order reception is normally completed. The third parameter represents a return destination when order reception fails owing to cancellation by the user or a communication problem. In the first embodiment, an HTML document is invoked by the HTTP protocol.

The second and third parameters are used in processing (to be described later), and thus saved as a text file in the work area of the HDD 209 so as to be able to refer to them later.

Referring back to FIG. 10, if the user wants to print the content entity of the browsing image 1101 displayed in the window while the content browsing window 1100 is displayed, he/she issues an instruction via the KB 208 to the print request button of the window. The document browsing unit 401 transmits an order receiving unit activation request to the print service provider computer 130 in accordance with the description of the print button display/operation directive 1112 in correspondence with the instruction to the print request button 1102. Note that a plurality of print service provider computers which provide print services may exist in the network. For descriptive convenience, the first embodiment assumes that a given print service provider has already been reserved (1003).

Upon reception of the order receiving unit activation instruction and parameters, the document providing unit 601 in the print service provider computer 130 activates the order receiving unit 602, and transfers the parameters to the order receiving unit 602.

The order receiving unit 602 analyzes the parameters, and specifies a content provider code and content code on the basis of the first parameter. The order receiving unit 602 searches the content provider management table 605 on the basis of the content provider code specified by the parameter, and generates a content print information path by using the searched record and the content code specified by the parameter. The second and third parameters are stored as a text file in the work area of the HDD 209. The order receiving unit 602 issues an acquisition request for the content print information 700 to the content provider computer 120 by using the generated content print information path (1004).

The document providing device 501 in the content provider computer 120 which has received the content print information acquisition request searches the content print information storage unit 503, and transmits the searched content print information to the print service provider computer 130 (1005).

The order receiving unit 602 in the print service provider computer 130 generates an order code, changes the order code 901, the content provider code 902, the content address 903 acquired from the received content print information, and the status 904 to “during order” in the order management table 607, and creates a new record like the order management record example 914.

The print information 702 in the content print information 700 is acquired. A setting item which falls within the range of limitations described in the information is acquired from the print service management table 606, and described in an HTML document for displaying a print condition designation window serving as an order information output.

Browsing data is acquired from a browsing data address described in the content information column 701. When overlay information exists, synthesis is executed in accordance with the information. The resultant information is saved in the work area of the HDD 209 as a preview image to be displayed in the print condition designation window (to be described later). The save position is added to a predetermined position in the HTML document for displaying the print condition designation window. The overlay information is saved in the printing spooler 608 together with an order code or a file name which allows searching the order management table 607 for the overlay information.

The HTML document which is so described as to display the print condition designation window in the user computer 110 is transmitted to the user computer 110 via the document providing unit 601 (1006).

The document browsing unit 401 in the user computer 110 displays the print condition designation window on the basis of the received HTML document.

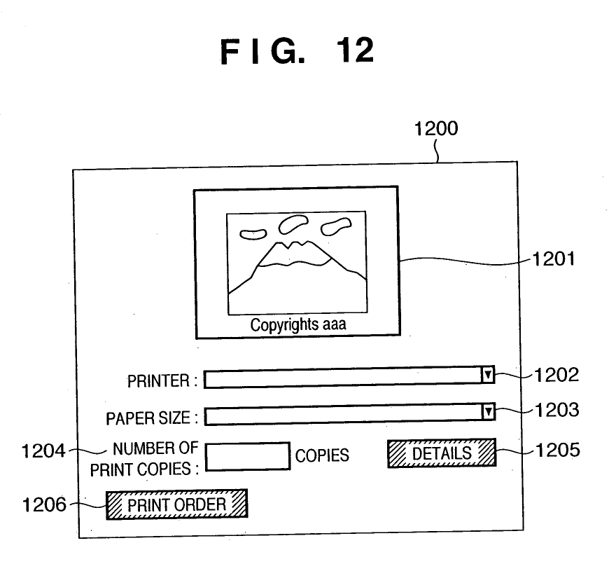

FIG. 12 shows the print condition designation window displayed by the document browsing unit 401 in the user computer 110.

In FIG. 12, reference numeral 1200 denotes a print condition designation window displayed in the first embodiment.

Reference numeral 1201 denotes a content preview window displayed in the window. The preview image 1201 is an image which reflects overlay information or the like by the order receiving unit 602. That is, the preview image 1201 is displayed as the preview of a print result.

Reference numeral 1202 denotes a printer selection column for selecting a printer model which prints a content. The printer selection column 1202 is formed such that the order receiving unit 602 selects a printable printer model from the content print information 700 and print service management table 606, printable printers are embedded as a list in an HTML document, and the user can select only a printable printer.

Reference numeral 1203 denotes a paper selection column for selecting print paper used to print a content. The paper selection column 1203 is formed such that the order receiving unit 602 selects printable paper sheets from the content print information 700 and print service management table 606, the printable printer sheets are embedded as a list in an HTML document, and the user can select only a printable paper sheet.

Reference numeral 1204 denotes a number-of-print-copies designation column.

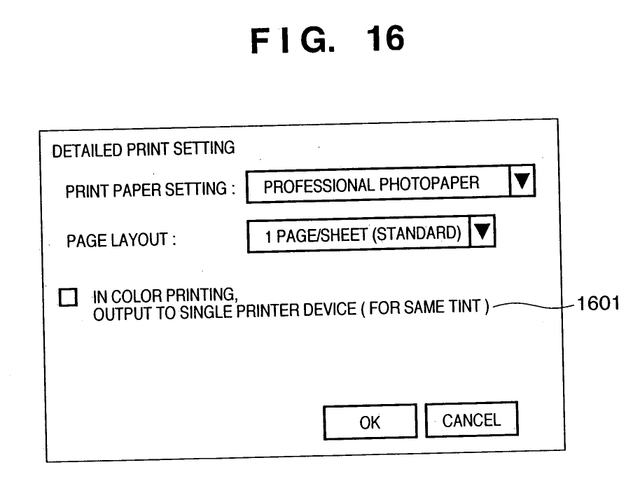

Reference numeral 1205 denotes a detailed setting link button for invoking a detailed setting window capable of performing detailed print settings such as designation of enlargement or reduction and the paper quality of print paper, except print conditions which can be set in the print condition designation window 1200. The detailed setting link button 1205 in the first embodiment is illustrated in FIG. 16.

As represented by 1601, a condition that printing devices are limited to a single one can be designated. That is, in order to keep the tint unchanged, output from a single printer device can be designated in color printing.

If no condition is designated, a default setting value, i.e., no limitation to a single one is adopted.

Reference numeral 1206 denotes a print order button for placing a print order.

Referring back to FIG. 10, state transition will be kept explained.

The user sets an output destination printer, paper size, and the number of copies by using the print condition designation window 1200 displayed by the document browsing unit 401 in the user computer 110. If necessary, the user invokes the detailed setting window by the detailed setting link button 1205, performs detailed settings, and then returns to the main window to set print conditions.

If the user confirms settings, he/she clicks the print order button 1206. The document browsing unit 401 then transmits an activation instruction for the order receiving unit 602 in the print service provider computer 130 serving as a link destination described in the HTML document. In transmitting the activation instruction, the document browsing unit 401 also transmits the print conditions set in the print condition designation window 1200 and detailed setting window together with an order code embedded in advance in the print condition designation window 1200 (1007).

The document providing unit 601 in the print service provider computer 130 activates the order receiving unit 602 again.

The order receiving unit 602 searches the order management table 607 for a record having the order code in parameters, and sets the print conditions in the searched record.

A confirmation window HTML document is transmitted to the user computer 110 via the document providing unit 601 in order to display a confirmation window for confirming execution of printing under the print conditions set by the user (1008).

Upon reception of the confirmation window HTML document, the document browsing unit 401 in the user computer 110 displays the confirmation window.

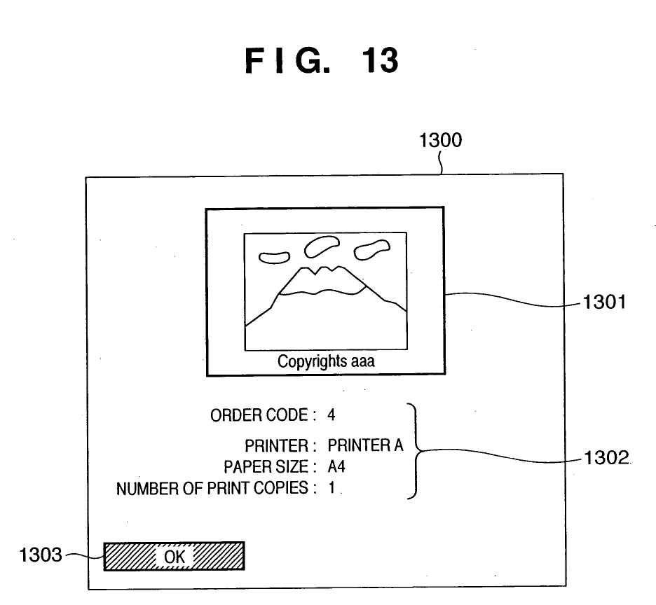

FIG. 13 shows a display example of the confirmation window.

In FIG. 13, reference numeral 1300 denotes a confirmation window.

Reference numeral 1301 denotes a preview image identical to the preview image 1201 displayed in the print condition setting window 1200. The preview image 1301 provides a more preferable preview display by displaying a preview to be actually printed under conditions written in the order management table 607 when the order receiving unit 602 receives the print conditions.

Reference numeral 1302 denotes a print condition confirmation column which displays an order code and the like that allow the order receiving unit 602 to uniquely determine the print conditions and order set in the order management table 607.

Reference numeral 1303 denotes a confirmation button.

Referring back to FIG. 10, the user confirms the preview image 1301 and print conditions 1302, clicks the button 1303 to determine a print order, and issues an order determination instruction to the print order receiving unit 602 so as to execute printing (1009).

Based on the order determination instruction, the document providing unit 601 in the print service provider 130 searches the order management table 607 for a record having the order code received as a parameter, and sets “during image collection” in the status 904 of the searched record.

The order receiving unit 602 invokes the second parameter stored in the HDD 209 in 1004, and requests the content provider computer 120 to display in the user computer 110 an HTML document at a URL described in the second parameter. If it is difficult due to limitations on the HTTP protocol or HTML document format to directly request the content provider computer 120, an HTML document which contains a link to the second parameter is temporarily transmitted to the user computer 110. A window stored in the content provider computer 120 can be displayed by describing in the document an automatic transmission request for the page of the second parameter.

The order receiving unit 602 activates the print data creation unit 603, ending the processing (1010).

The document providing unit 501 of the content provider computer 120 searches the content browsing window storage unit 504 for the HTML document which has been requested in 1010 by the print service provider computer 130 to be transmitted to the user computer 110. The document providing unit 501 transmits the searched HTML document to the user computer 110 (1011).

The document browsing unit 401 of the user computer 110 displays an order reception completion window on the basis of the HTML document received from the content provider computer 120. The order reception completion window displays a description that a print order has been received, and a link for continuing content browsing in the content provider computer 120 (1012).

In the print service provider computer 130, the print data creation unit 603 which has been activated in process 1010 receives the order code as a parameter upon activation, searches the order management table 607 on the basis of the order code, and acquires the content address 903 from the searched record. A content acquisition request is issued to the content provider computer 120 on the basis of the content address (1013).

Upon reception of the content entity acquisition request from the print service provider computer 130, the document providing unit 501 in the content provider computer 120 acquires a content requested to be acquired from the content storage unit 502, and transmits the content to the print service provider computer 130 (1014).

The print data creation unit 603 of the print service provider computer 130 which has received the content stores, in the printed material spooler 608 in a state identifiable by the order code, content data from the record in the order management table 607, and data necessary for printing such as various print settings and accessory information as print order information. The status 904 of the record in the order management table 607 is set to “wait for printing”, and the printing control unit 604 is activated, ending the processing (1015).

The printing control unit 604 searches for a record having the status 904 “wait for printing” in the order management table 607, and acquires the searched order code string. The printing control unit 604 extracts one order code from the order code string in accordance with a predetermined protocol, and acquires from the printed material spooler 608 data which corresponds to the code and is necessary for printing. The printing control unit 604 transmits the print data to an output destination printer to print (1016).

At the end of printing, the printing control unit 604 searches the order management table 607 on the basis of the order code subjected to printing, and sets the status 904 of the searched record to “printed”.

<Printing Designation of Limited Printing Device in First Embodiment>

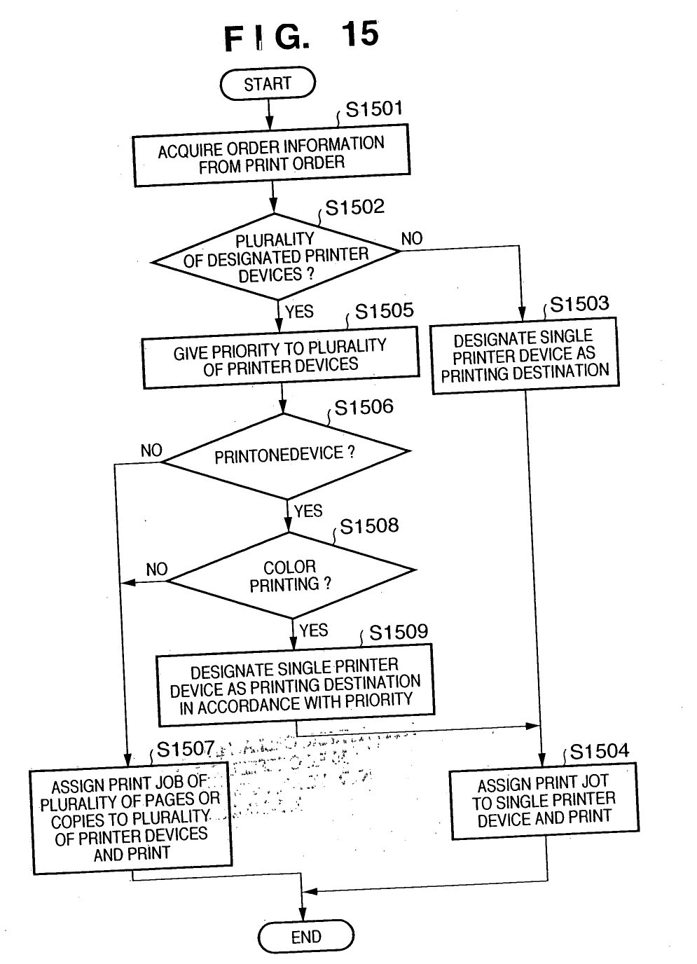

An example of printing designation in the first embodiment will be described. FIG. 15 is a flow chart.

Subsequent to 1016 in FIG. 10, printing of a print order 914 having, e.g., print order information shown in FIG. 14 will be explained.

In step 1501, order information associated with a print order is acquired. In step 1502, the print service provider computer determines whether the printer type in the column 1402 represents a plurality of printers connected to the printer control device 301. This is based on the assumption that, at a print shop which enables large-scale printing, a plurality of printers of the same type are connected to parallel-print. If the number of designated printer devices is one, the printer control device 301 designates one printer device as a printing device in step 1503, and causes one printer to print in accordance with a print order as a single print job in step 1504.

If the printer type in the column 1402 is determined in step 1502 to represent a plurality of printers, the printer control device 301 gives the use possibility priority of a plurality of connected printer devices. The priority may be given in consideration of various requirements such as the utilization by another control device or print job, the degree of idleness of a printer job, and the size of the printer buffer memory. Alternatively, the priority may be mechanically equally given, or scheduling such as general round robin may be executed. Distribution of print jobs is assumed to be realized optimally or by a predetermined rule in the print shop service provider.

In step 1506, PRINTONEDEVICE of print order information shown in FIG. 14 is searched. If a field exists and “1” is set, the print order information is determined to designate output from a single printer device.

If output from a single printer device is not designated in step 1506, the print order advances to step 1507 to distribute print operations of pages or copies to a plurality of print jobs. Printing is properly assigned to a plurality of printer devices having the priority given in step 1505, completing printouts.

If output from a single printer device is designated in step 1506, whether color printing has been set is determined in step 1508.

If monochrome printing is determined in step 1508, no tint difference generally occurs as far as printers are of the same type. The processing advances to step 1507 to efficiently print automatically by a plurality of printer devices of the same type.

If color printing is determined in step 1508, an appropriate printer is designated as a printing device from printing devices having the priority given in step 1505. The processing advances to step 1504 to print by the single printing device in accordance with the print order.

In this manner, a content entity in the content provider computer 120 is printed in accordance with a print instruction through a content browsing window stored in the content provider computer 120.

As described above, according to the first embodiment, the content provider can have content providing services other than data download without holding any print solution. The user can be provided with services in various print forms other than a home printer. The print service provider can provide print services without any fund or license cost for holding contents and any influence of the content quality on the business. For example, in a print business model in which many printing devices are connected to cope with large-scale printing demands and a print service provider which connects a plurality of printing devices of the same type exists, the user can designate the same tint for printed materials in placing a print order of a plurality of color pages or color copies. The print service provider prints with the same tint in accordance with the designated print order. In normal printing free from such designation, an optimal print solution can realized.

[Second Embodiment]

The second embodiment will exemplify a print reorder. The system configuration and computer configuration of the second embodiment are the same as those of the first embodiment. As for various data and flows, a description of similar parts will be simplified or omitted, and different parts will be mainly described.

<Content Print Information>

In content print information in the second embodiment, information on content reprinting has the following pieces of information in addition to examples in the first embodiment.

\mathring{1} print service provider information

\mathring{2} printer device information

\mathring{3} print setting information

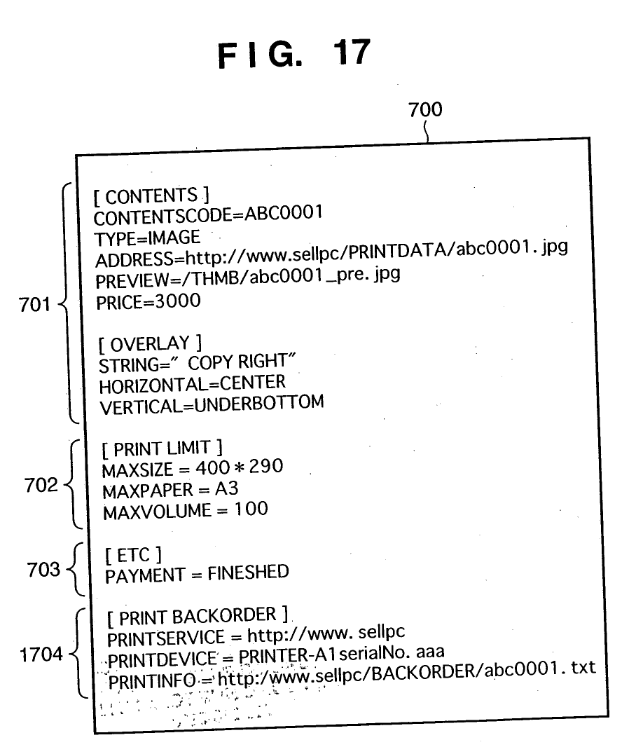

FIG. 17 is a view showing an example of content print information in the second embodiment.

In FIG. 17, data 700 to 703 are the same as those in the first embodiment.

In FIG. 17, reference numeral 1704 denotes a reorder information column out of content print information in the second embodiment that is set when the user has placed a print order once.

“PRINTSERVICE=http://www.sellpc” represents a print service provider which has received a print order before.

“PRINTDEVICE=PRINTER-A1serialNo.aaa” represents an ID which allows uniquely identifying a printing device which has printed before.

“PRINTINFO=http://www.sellpc/BACKORDER/abc0001.txt” represents a file address at which print setting information set in the printing device that has printed before is saved.

Information set in the column 1704 changes to idle data if the user has not placed any print order of the content before.

<Print Order Information>

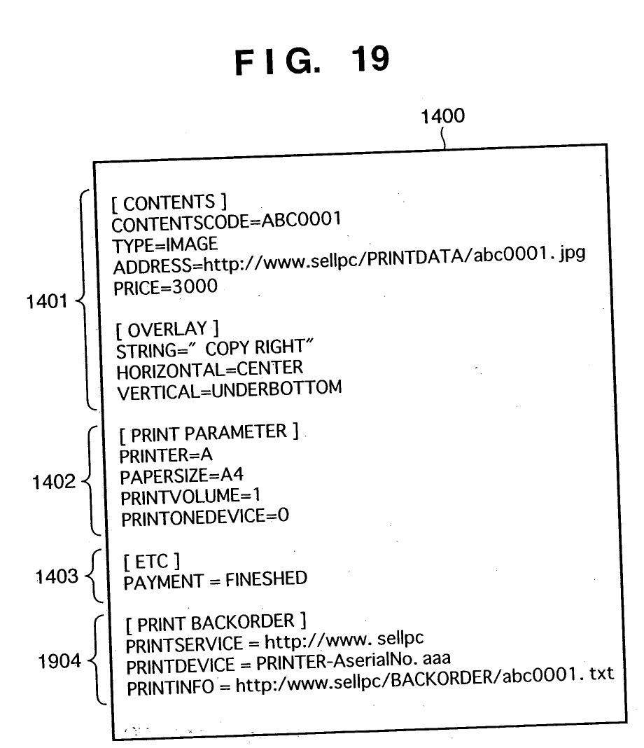

The print order information schematic view of FIG. 9 associated with, e.g., the database record 914 is illustrated in FIG. 19 in the second embodiment.

In FIG. 19, data 1400 to 1403 are the same as those in the first embodiment.

In FIG. 19, reference numeral 1904 denotes an information column out of content print information in the second embodiment. The information column 1904 in the second embodiment is expressed by a header item “[BACKORDER]”.

The information column 1904 is set when the user has placed a print order once.

“PRINTSERVICE=http://www.sellpc” represents a print service provider which has received a print order before.

“PRINTDEVICE=PRINTER-AserialNo.aaa” represents an ID which allows uniquely identifying a printing device which has printed before.

“PRINTINFO=http://www.sellpc/BACKORDER/abc0001.txt” represents a file address at which print setting information set in the printing device that has printed before is saved.

Information set in the column 1904 changes to idle data if the user has not placed any print order of the content before.

<Another Processing Flow in System>

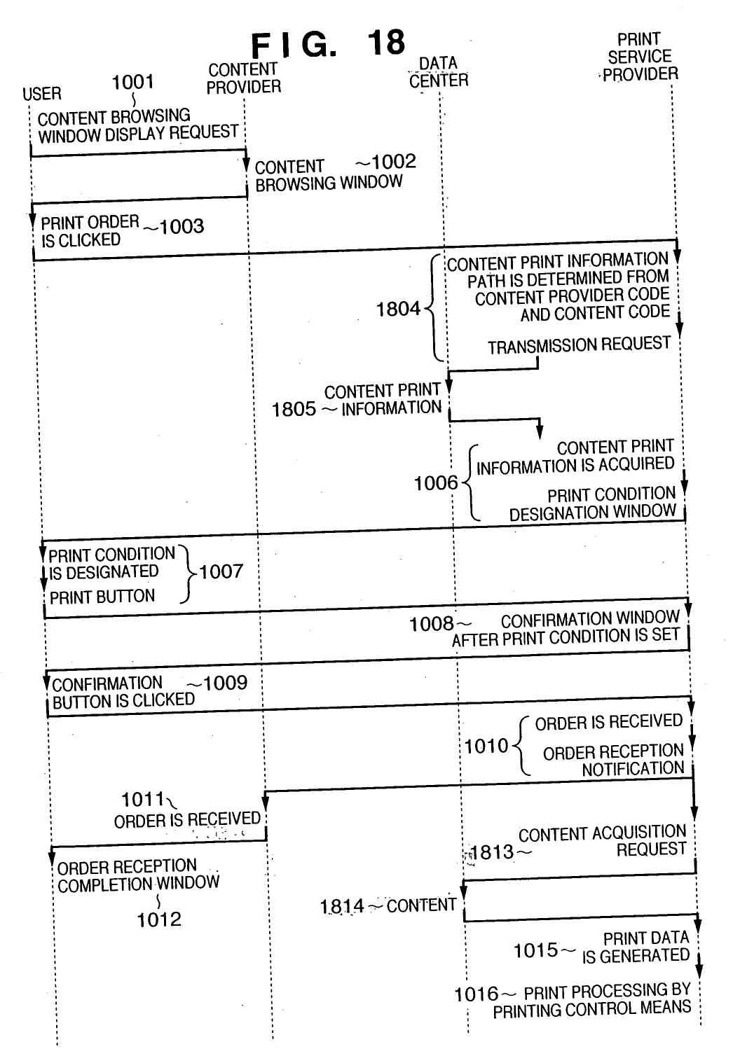

A processing flow in the second embodiment will be explained with reference to FIG. 18 and other drawings. In FIG. 18, the same reference numerals as in FIG. 10 denote the same processes.

FIG. 18 is a chart for explaining a processing flow between a user computer 110, a content provider computer 120, a data center 140, and a print service provider 130 in the second embodiment. In the following description, the user browses a content browsing window in the content provider 120 by using the user computer 110, and places a print order with the print service provider 130.

The user issues a content browsing window display request to the content provider computer 120 by using a document browsing unit 401 in the user computer 110. The content browsing window display request designates the URL of a content browsing window desired by the user on the basis of the HTTP protocol. The URL is designated by directly inputting it to the document browsing unit 401 by the user using a KB 208, or selecting the link of a window to be displayed by the document browsing unit 401 on the basis of the HTML document (1001).

The content browsing window display request issued by the user computer 110 is received through an NETIF 204 by a document providing unit 501 in the content provider computer 120 via a network 100. The document providing unit 501 which has received the content browsing window display request transmits, to the user computer 110 which has issued the request, an HTML document which corresponds to the designated URL and is stored in a content browsing window storage unit 504, and browsing data which is linked to the document and stored in a content storage unit 502 (1002).

The document browsing unit 401 in the user computer 110 that has received the HTML document and browsing data displays a content browsing window on the basis of the HTML document.

The content browsing window will be explained with reference to FIGS. 11A and 11B.

FIG. 11A shows the content browsing window. FIG. 11B shows an example of the HTML document which is transmitted from the content provider computer 120 and is so described as to display the browsing window.

In FIG. 11A, reference numeral 1100 denotes a content browsing window which is displayed in the user computer 110 in the second embodiment.

Reference numeral 1101 denotes a browsing image using content browsing data displayed in the window. The content browsing data is transmitted from the content storage unit 502 in the content provider computer 120, and displayed in the window by the document browsing device 401.

Reference numeral 1102 denotes a print request button for issuing a print request for a content displayed in the window to the print service provider computer 130.

In FIG. 11B, reference numeral 1110 denotes an HTML document which describes, e.g., the display form and link of the content browsing window 1100.

Reference numeral 1111 denotes a browsing display directive which is so described as to display a browsing image. The browsing display directive 1111 describes the existing position and image file name of browsing data in the second embodiment.

Reference numeral 1112 denotes a print button display/operation directive which is so described as to display a print button, and describes an operation instruction to the document browsing unit 401 when an operation instruction is issued by, e.g., clicking the print button. A description “http://www.print.com/pps/pps.exe” in the print button display/directive is an activation instruction for a CGI program serving as an order receiving unit 602 to the service provider computer 130. “NO=0001ABC001” is the first parameter upon activating the order receiving unit 602. A plurality of parameters can be designated by “&”, and the second parameter is “FINISH=http://www.sellpc/FINISH/ABC0001.html”. Similarly, the third parameter is “CANCEL=http://www.sellpc/CANCEL/ABC0001.html”. The first parameter in the second embodiment is formed by a content provider code stored in a content provider code 801 of a content provider management table 605, and a content code stored in the content print information 700. The second and third parameters represent return destinations to windows provided by the content provider after the end of order receiving processing. The second parameter represents a return destination when order reception is normally completed. The third parameter represents a return destination when order reception fails owing to cancellation by the user or a communication problem. In the second embodiment, an HTML document is invoked by the HTTP protocol.

The second and third parameters are used in processing (to be described later), and thus saved as a text file in the work area of an HDD 209 so as to be able to refer to them later.

Referring back to FIG. 18, if the user wants to print the content entity of the browsing image 1101 displayed in the window while the content browsing window 1100 is displayed, he/she issues an instruction via the KB 208 to the print request button of the window. The document browsing unit 401 transmits an order receiving unit activation request to the print service provider computer 130 in accordance with the description of the print button display/operation directive 1112 in correspondence with the instruction to the print request button 1102. Note that a plurality of print service provider computers which provide print services may exist in the network. For descriptive convenience, the second embodiment assumes that a given print service provider has already been reserved (1003).

Upon reception of the order receiving unit activation instruction and parameters, a document providing unit 601 in the print service provider computer 130 activates the order receiving unit 602, and transfers the parameters to the order receiving unit 602.

The order receiving unit 602 analyzes the parameters, and specifies a content provider code and content code on the basis of the first parameter. The order receiving unit 602 searches the content provider management table 605 on the basis of the content provider code specified by the parameter, and generates a content print information path by using the searched record and the content code specified by the parameter. A basic address 802 in the content provider management table 605 stores the basic address of the data center 140, and the data center 140 serves as a content print information acquisition destination. The second and third parameters are stored as a text file in the work area of the HDD 209. The order receiving unit 602 issues an acquisition request for the content print information 700 to the data center 140 by using the generated content print information path (1804).

The document providing device 501 in the data center 140 which has received the content print information acquisition request searches a content print information storage unit 503, and transmits the searched content print information to the print service provider computer 130. If the user has printed the same content before as a result of search, reorder information in the column 1704 is also transmitted (1805).

The order receiving unit 602 in the print service provider computer 130 which has acquired the content print information from the data center 140 generates an order code, changes the order code 901, the content provider code 902, the content address 903 acquired from the received content print information, and the status 904 to “during order” in the order management table 607, and creates a new record like the order management record example 914.

The print information 702 in the content print information 700 is acquired. A setting item which falls within the range of limitations described in the information is acquired from a print service management table 606, and described in an HTML document for displaying a print condition designation window serving as an order information output.

Browsing data is acquired from a browsing data address described in the content information column 701. When overlay information exists, synthesis is executed in accordance with the information. The resultant information is saved in the work area of the HDD 209 as a preview image to be displayed in the print condition designation window (to be described later). The save position is added to a predetermined position in the HTML document for displaying the print condition designation window. The overlay information is saved in the printing spooler 608 together with an order code or a file name which allows searching the order management table 607 for the overlay information.

The HTML document which is so described as to display the print condition designation window in the user computer 110 is transmitted to the user computer 110 via the document providing unit 601 (1006).

The document browsing unit 401 in the user computer 110 displays the print condition designation window on the basis of the received HTML document.

FIG. 12 shows the print condition designation window displayed by the document browsing unit 401 in the user computer 110.

In FIG. 12, reference numeral 1200 denotes a print condition designation window displayed in the second embodiment. If information on a previous print order of the same content by the user exists in 1005, the print condition designation window changes for a reorder. An example of the reorder print condition designation window will be described later.

Reference numeral 1201 denotes a content preview window displayed in the window. The preview image 1201 is an image which reflects overlay information or the like by the order receiving unit 602. That is, the preview image 1201 is displayed as the preview of a print result.

Reference numeral 1202 denotes a printer selection column for selecting a printer model which prints a content. The printer selection column 1202 is formed such that the order receiving unit 602 selects a printable printer model from the content print information 700 and print service management table 606, printable printers are embedded as a list in an HTML document, and the user can select only a printable printer.

Reference numeral 1203 denotes a paper selection column for selecting print paper used to print a content. The paper selection column 1203 is formed such that the order receiving unit 602 selects printable paper sheets from the content print information 700 and print service management table 606, the printable printer sheets are embedded as a list in an HTML document, and the user can select only a printable paper sheet.

Reference numeral 1204 denotes a number-of-print-copies designation column.

Reference numeral 1205 denotes a detailed setting link button for invoking a detailed setting window capable of performing detailed print settings such as designation of enlargement or reduction and the paper quality of print paper, except print conditions which can be set in the print condition designation window 1200. The detailed setting link button 1205 in the second embodiment is illustrated in FIG. 16. As represented by 1601, a condition that printing devices are limited to a single one can be designated. That is, in order to keep the tint unchanged, output from a single printer device can be designated in color printing. If no condition is designated, a default setting value, i.e., no limitation to a single one is adopted.

Referring back to FIG. 18, state transition will be kept explained.

The user sets an output destination printer, paper size, and the number of copies by using the print condition designation window 1200 displayed by the document browsing unit 401 in the user computer 110. If necessary, the user invokes the detailed setting window by the detailed setting link button 1205, performs detailed settings, and then returns to the main window to set print conditions.

If the user confirms settings, he/she clicks a print order button 1206. The document browsing unit 401 then transmits an activation instruction for the order receiving unit 602 in the print service provider computer 130 serving as a link destination described in the HTML document. In transmitting the activation instruction, the document browsing unit 401 also transmits the print conditions set in the print condition designation window 1200 and detailed setting window together with an order code embedded in advance in the print condition designation window 1200 (1007).

The document providing unit 601 in the print service provider computer 130 activates the order receiving unit 602 again.

The order receiving unit 602 searches the order management table 607 for a record having the order code in parameters, and sets the print conditions in the searched record.

A confirmation window HTML document is transmitted to the user computer 110 via the document providing unit 601 in order to display a confirmation window for confirming execution of printing under the print conditions set by the user (1008).

Upon reception of the confirmation window HTML document, the document browsing unit 401 in the user computer 110 displays the confirmation window.

FIG. 13 shows a display example of the confirmation window.

In FIG. 13, reference numeral 1300 denotes a confirmation window.

Reference numeral 1301 denotes a preview image identical to the preview image 1201 displayed in the print condition setting window 1200. The preview image 1301 provides a more preferable preview display by displaying a preview to be actually printed under conditions written in the order management table 607 when the order receiving unit 602 receives the print conditions.

Reference numeral 1302 denotes a print condition confirmation column which displays an order code and the like that allow the order receiving unit 602 to uniquely determine the print conditions and order set in the order management table 607.

Reference numeral 1303 denotes a confirmation button.

Referring back to FIG. 18, the user confirms the preview image 1301 and print conditions 1302, clicks the button 1303 to determine a print order, and issues an order determination instruction to the print order receiving unit 602 so as to execute printing (1009).

Based on the order determination instruction, the document providing unit 601 in the print service provider 130 searches the order management table 607 for a record having the order code received as a parameter, and sets “during image collection” in the status 904 of the searched record.

The order receiving unit 602 invokes the second parameter stored in the HDD 209 in 1004, and requests the content provider computer 120 to display in the user computer 110 an HTML document at a URL described in the second parameter. If it is difficult due to limitations on the HTTP protocol or HTML document format to directly request the content provider computer 120, an HTML document which contains a link to the second parameter is temporarily transmitted to the user computer 110. A window stored in the content provider computer 120 can be displayed by describing in the document an automatic transmission request for the page of the second parameter.

The order receiving unit 602 activates a print data creation unit 603, ending the processing (1010).

The document providing unit 501 of the content provider computer 120 searches the content browsing window storage unit 504 for the HTML document which has been requested in 1010 by the print service provider computer 130 to be transmitted to the user computer 110. The document providing unit 501 transmits the searched HTML document to the user computer 110 (1011).

The document browsing unit 401 of the user computer 110 displays an order reception completion window on the basis of the HTML document received from the content provider computer 120. The order reception completion window displays a description that a print order has been received, and a link for continuing content browsing in the content provider computer 120 (1012).

In the print service provider computer 130, the print data creation unit 603 which has been activated in process 1010 receives the order code as a parameter upon activation, searches the order management table 607 on the basis of the order code, and acquires the content address 903 from the searched record. A content acquisition request is issued to the data center 140 on the basis of the content address (1813).

Upon reception of the content entity acquisition request from the print service provider computer 130, the document providing unit 501 in the data center 140 acquires a content requested to be acquired from the content storage unit 502, and transmits the content to the print service provider computer 130 (1814).

The print data creation unit 603 of the print service provider computer 130 which has received the content stores, in the printed material spooler 608 in a state identifiable by the order code, content data from the record in the order management table 607, and data necessary for printing such as various print settings and accessory information as print order information. The status 904 of the record in the order management table 607 is set to “wait for printing”, and the printing control unit 604 is activated, ending the processing (1015).

The printing control unit 604 searches for a record having the status 904 “wait for printing” in the order management table 607, and acquires the searched order code string. The printing control unit 604 extracts one order code from the order code string in accordance with a predetermined protocol, and acquires from the printed material spooler 608 data which corresponds to the code and is necessary for printing. The printing control unit 604 transmits the print data to an output destination printer to print (1016).

At the end of printing, the printing control unit 604 searches the order management table 607 on the basis of the order code subjected to printing, and sets the status 904 of the searched record to “printed”.

<Printing in Second Embodiment>

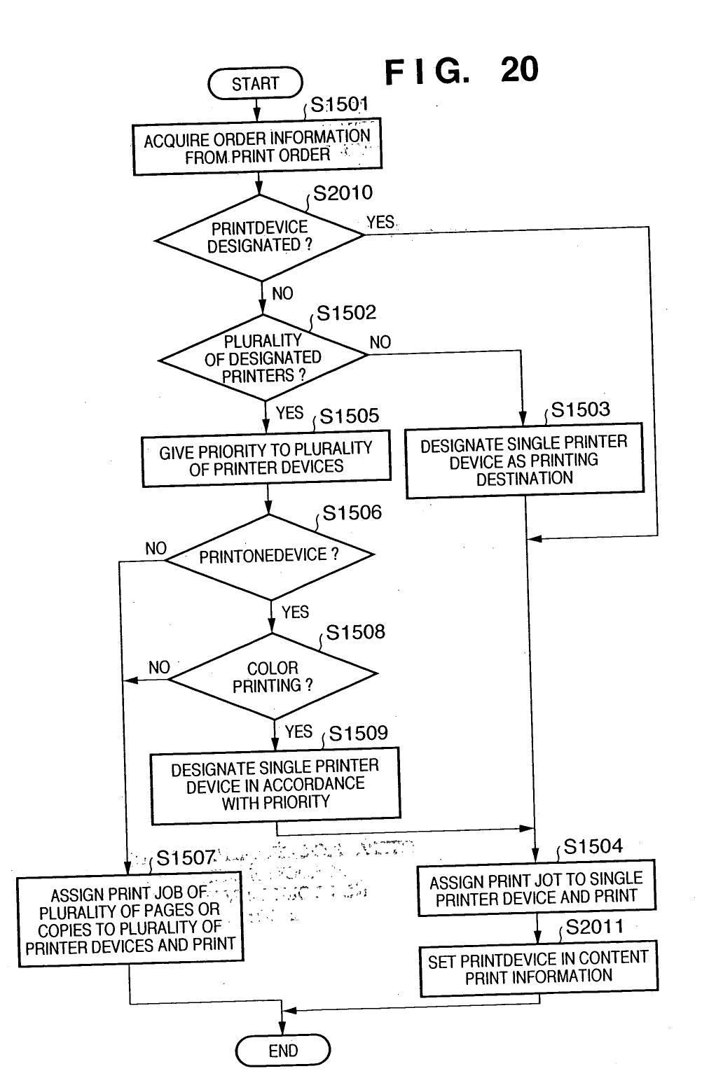

An example of print processing in the second embodiment will be described. FIG. 20 is a flow chart. In FIG. 20, the same reference numerals as in FIG. 15 denote the same processes.

Subsequent to 1016 in FIG. 18, printing of a print order 914 having, e.g., print order information shown in FIG. 19 will be explained.

In step 1501, order information associated with a print order is acquired.

In step 2010, the print service provider computer searches for and refers to PRINTDEVICE in the column 1904, and determines whether order information is an order which designates a specific printing device. For a reorder, the order information designates a single printing device so as not to change the tint from that of a previous order. A reorder will be described later. In normal printing, only the printer type (PRINTER) is designated, and the processing advances to step 1502.

In step 1502, the print service provider computer determines whether the printer type in the column 1402 represents a plurality of printers connected to the printer control device 301. This is based on the assumption that, at a print shop which enables large-scale printing, a plurality of printers of the same type are connected to parallel-print. If the number of designated printer devices is one, the printer control device 301 designates one printer device as a printing device in step 1503, and causes one printer to print in accordance with a print order as a single print job in step 1504.

If the printer type in the column 1402 is determined in step 1502 to represent a plurality of printers, the printer control device 301 gives the use possibility priority of a plurality of connected printer devices. The priority may be given in consideration of various requirements such as the utilization by another control device or print job, the degree of idleness of a printer job, and the size of the printer buffer memory. Alternatively, the priority may be mechanically equally given, or scheduling such as general round robin may be executed. Distribution of print jobs is assumed to be realized optimally or by a predetermined rule in the print shop service provider.

In step 1506, PRINTONEDEVICE of print order information shown in FIG. 19 is searched. If a field exists and “1” is set, the print order information is determined to designate output from a single printer device.

If output from a single printer device is not designated in step 1506, the print order advances to step 1507 to distribute print operations of pages or copies to a plurality of print jobs. Printing is properly assigned to a plurality of printer devices having the priority given in step 1505, completing printouts.

If output from a single printer device is designated in step 1506, whether color printing has been set is determined in step 1508.

If monochrome printing is determined in step 1508, no tint difference generally occurs as far as printers are of the same type. The processing advances to step 1507 to efficiently print automatically by a plurality of printer devices of the same type.

If color printing is determined in step 1508, an appropriate printer is designated as a printing device from printing devices having the priority given in step 1505. The processing advances to step 1504 to print by the single printing device in accordance with the print order.

In step 2011 subsequent to step 1504, a unique ID such as a serial or network address capable of specifying a single printer device is stored in PRINTDEVICE in the column 1704 of content print information in order to leave a log representing which printing device has processed the print order.

As a result, a content entity in the content provider computer 120 is printed in accordance with a print instruction through a content browsing window stored in the content provider computer 120.

<Reorder Printing in Second Embodiment>

The second embodiment will exemplify a case wherein output to the same printing device which keeps the same color tint can be realized.

The processing flow is the same as that shown in the FIG. 18. In 1001, the user starts content browsing, and the processing advances to 1002, 1003, and 1804.

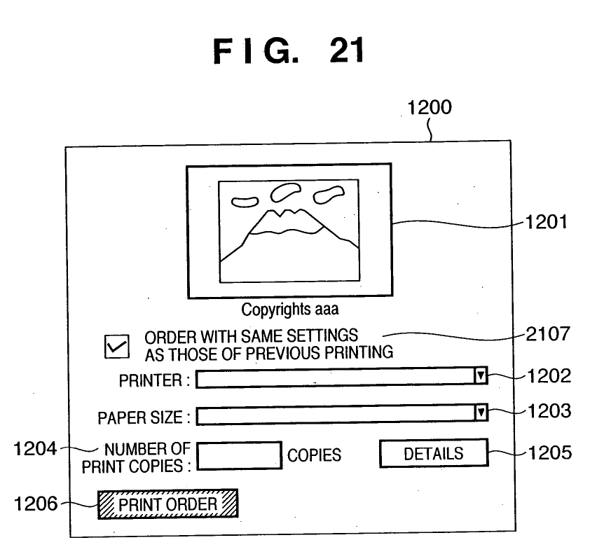

In 1805, if a reorder [BACKORDER] tag and reorder printing device designation PRINTDEVICE in the column 1704 exist in content print information, print settings in the column 1704 are set and reflected in a print condition window. The print condition window displayed in the user computer in 1006 changes from FIG. 12 to FIG. 21.

“Print with the same settings as the previous ones” is checked, as represented by 2107, and print conditions in columns 1203, 1202, and 1205 are disabled and cannot be changed. The number of print copies for a reorder in a column 1204 can be set.

In 1010 after 1007, 1008, and 1009, the previous printing device PRINTDEVICE is set in the print order information 914 shown in FIG. 14, and a print order is placed. If settings are done without any check mark of a “single” column 1707, the same normal print settings as those in FIG. 12 are obtained without any setting in PRINTDEVICE.

Subsequent to 1016 after 1011, 1012, 1813, 1814, and 1015 in FIG. 18, printing of a print order 914 having, e.g., print order information shown in FIG. 19 will be explained.

In step 1501 of FIG. 15, order information associated with a print order is acquired.

In step 2010, the print service provider computer searches for and refers to PRINTDEVICE in the column 1904, and determines whether order information is an order which designates a specific printing device. For a reorder, the order information designates a single printing device so as not to change the tint from that of a previous order. In this case, the processing advances to step 1504 to execute reordered printing by the same designated device as a printing device which has printed before. Even reordered printing can ensure the same tint. The user can obtain an identical printout without any consciousness of such complicated processing.

An example of a reorder will be explained.

<Printing Designation for Reorder>

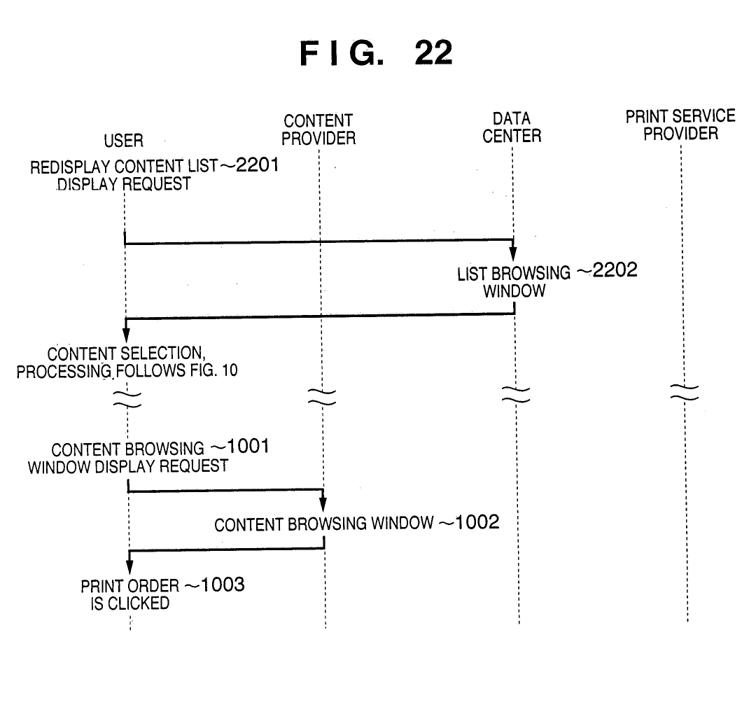

As shown in the flow chart of FIG. 22, as processing prior to FIG. 18, the user searches for content print information in the data center 140 in advance, refers to the past printing log of the user to obtain the list (2201), and selects a proper content for a reorder (2202). Reordered printing is performed along the same flow as that in FIG. 18.

As described above, according to the second embodiment, the content provider can have content providing services other than data download without holding any print solution. The user can be provided with services in various print forms other than a home printer. The print service provider can provide print services without any fund or license cost for holding contents and any influence of the content quality on the business. For example, in a print business model in which many printing devices are connected to cope with large-scale printing demands and a print service provider which connects a plurality of printing devices of the same type exists, the user can obtain a printed product in the same tint as that of a previous order by performing reordered printing by the same printing device. This can be easily realized.

The above embodiments can be realized by executing a program by a computer. A unit for supplying the program to the computer, e.g., a computer-readable recording medium such as a CD-ROM which records the program or a transmission medium such as the Internet which transmits the program can also be applied as an embodiment of the present invention. A computer program product such as the computer-readable recording medium which records the program can also be applied as an embodiment of the present invention. The program, recording medium, transmission medium, and computer program product fall within the gist of the present invention. As the recording medium, a flexible disk, hard disk, optical disk, magnetooptical disk, CD-ROM, magnetic tape, nonvolatile memory card, ROM, and the like can be used.

The above embodiments are merely examples of the present invention in practicing the present invention, and the technical range of the present invention should not be definitely interpreted by the embodiments. In other words, the present invention can be practiced in various forms without departing from the technical concept or main features of the present invention.

As many apparently widely different embodiments of the present invention can be made without departing from the spirit and scope thereof, it is to be understood that the invention is not limited to the specific embodiments thereof except as defined in the appended claims.

What is claimed is:

1. A print service apparatus comprising:
generation unit adapted to generate print setting information including a print device ID by which a print device used for previously printing can be identified when said print service apparatus has been received a print order from a user terminal and performed a print service; and
display control unit adapted to control to display information related with said print device identified by said print device ID in a browsing window of the user terminal based on said generated print setting information.

2. The apparatus according to claim 1, wherein said print setting information includes information related with a print service provider having said print device.

3. The apparatus according to claim 1, wherein the information related with a print service provider contains print service information serving as a printing destination, a printer type capable of printing by the print service, or a paper size.

4. The apparatus according to claim 1, wherein said print setting information includes information related with print conditions set to said print device.

5. The apparatus according to claim 4, wherein said print conditions include tint.

6. The apparatus according to claim 1, further comprising:
receiving unit adapted to receive a condition for the plurality of print device; and
selecting unit adapted to select the print device based on the received condition.

7. The apparatus according to claim 6, wherein the condition for selecting the print device shows a color printing using only a print device, and said selecting unit selects a print device.

8. A method of controlling a print service apparatus, comprising the steps of:
generating print setting information including a print device ID by which a print device used for previously printing can be identified when said print service apparatus has been received a print order from a user terminal and performed a print service; and
controlling to display information related with said print device identified by said print device ID in a browsing window of the user terminal based on said generated print setting information.

9. A program for controlling a print service apparatus according to claim 8.

10. A storage medium for computer-readably storing a program according to claim 9.

11. A print service system comprising:
first judging unit adapted to judge whether or not a content to be printed is color data; and
print control unit adapted to control to print the content using a print device of a plurality of print devices when said first judging unit judge that the content is color.

12. The system according to claim 11, further comprising second judging unit adapted to judge whether or not a print order is reorder, wherein said print control unit controls to print the content using the same print device as used at a previous print order when a result of judging is reorder.

13. The system according to claim 12, wherein said print control unit set the same tint as set at a previous print order to the same print device.

14. The system according to claim 11, wherein said print control unit includes prohibiting unit adapted to prohibit to limit a print device to be used in accordance with an instruction of a user.

15. A print service method comprising the steps of:
judging whether or not a content to be printed is color data; and
controlling to print the content using a print device of a plurality of print devices when the content is judged to be color.
